(19) United States
(12) Patent Application Publication
(10) Pub. No.: US 2015/0172066 A1
(43) Pub. Date: Jun. 18, 2015

(54) PRACTICAL IMPLEMENTATION ASPECTS OF UNICAST FETCH FOR HTTP STREAMING OVER EMBMS

(71) Applicant: QUALCOMM Incorporated, San Diego, CA (US)

(72) Inventors: Ralph Akram GHOLMIEH, San Diego, CA (US); Nagaraju NAIK, San Diego, CA (US); Carlos Marcelo Dias PAZOS, Carlsbad, CA (US); Chaitali GUPTA, Sunnyvale, CA (US); Osama LOTFALLAH, San Diego, CA (US); Nermeen Ahmed BASSIOUNY, San Diego, CA (US); Nagaraja SHIVASHANKAR, San Diego, CA (US)

(21) Appl. No.: 14/566,611

(22) Filed: Dec. 10, 2014

Related U.S. Application Data
(60) Provisional application No. 61/916,074, filed on Dec. 13, 2013.

(51) Int. Cl. H04L 12/18

(52) U.S. Cl. CPC H04L 12/189

(57) ABSTRACT

A method, an apparatus, and a computer program product for wireless communication are provided. The apparatus may be an eMBMS middleware. The apparatus receives a request to activate reception of an eMBMS service. The apparatus receives a request for a segment associated with the eMBMS service. The apparatus determines whether the segment of the eMBMS service is available at the eMBMS middleware. The apparatus fetches the segment from the unicast server if the segment is not available at the eMBMS middleware.

### CROSS-REFERENCE TO RELATED APPLICATION(S)

This application claims the benefit of U.S. Provisional Application Ser. No. 61/916,074, entitled “PRACTICAL IMPLEMENTATION ASPECTS OF UNICAST FETCH FOR HTTP STREAMING OVER EMBMS” and filed on Dec. 13, 2013, which is expressly incorporated by reference herein in its entirety.

### BACKGROUND

1. Field

The present disclosure relates generally to communication systems, and more particularly, to utilizing an evolved multimedia broadcast multicast service.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be an evolved Multimedia Broadcast Multicast Service (eMBMS) middleware. The apparatus may be configured to receive a request to activate reception of an eMBMS service and a request for a segment associated with the eMBMS service. The apparatus may further be configured to determine whether the segment of the activated eMBMS service is available at the eMBMS middleware. The apparatus fetches the segment from a unicast server if the segment is not available at the eMBMS middleware.

In another aspect, the apparatus for wireless communication may include an eMBMS middleware, and the apparatus may include a memory and at least one processor coupled to the memory. The at least one processor may be configured to: receive a request to activate reception of an eMBMS service, receive a request for a segment associated with the eMBMS service, determine whether the segment of the activated eMBMS service is available at the eMBMS middleware, and fetch the segment from a unicast server upon the determination that the segment is not available at the middleware.

In another aspect, the apparatus for wireless communication may include an eMBMS middleware. The apparatus may include means for receiving a request to activate reception of an eMBMS service, means for receiving a request for a segment associated with the eMBMS service, and means for determining whether the segment of the activated eMBMS service is available at the eMBMS middleware. The apparatus may further include a transceiver configured to fetch the segment from a unicast server upon the determination that the segment is not available at the eMBMS middleware.

In another aspect, the computer program product may be for an eMBMS middleware, and may include a computer-readable medium. The computer-readable medium includes code for receiving a request to activate reception of an eMBMS service, receiving a request for a segment associated with the eMBMS service, determining whether the segment of the activated eMBMS service is available at the eMBMS middleware, and fetching the segment from a unicast server if the segment is not available at the eMBMS middleware.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIG. 8 is an example time diagram for transmitting eMBMS service segments and segment requests time by a DASH client at a start of consumption of a DASH service.

FIG. 9 is an example call flow diagram illustrating a start of playback of an eMBMS HTTP streaming service.

FIG. 10 is an example system for DASH segment playback according to an embodiment.

FIG. 11 is an example set of time diagrams illustrating a broadcast delay and a unicast delay.

FIG. 12 is an example flow diagram illustrating a playback process of an eMBMS service according to a first approach where HTTP requests are served.

FIG. 13 is an example time diagram for transmitting eMBMS service segments and a segment request time by a DASH client, illustrating playback of option 1A and playback of option 1B according to the first approach.

FIG. 14 an example time diagram for transmitting eMBMS service segments and a segment request time by a DASH client, illustrating a corner case for option 1B according to the first approach.

FIG. 15 is an example time diagram of option 2A according to a second approach, where one of two segments is fetched over unicast (an HTTP request for a first segment is ignored).

FIG. 16 is an example time diagram of option 2B according to the second approach where two segments are fetched over unicast.

FIG. 17 is an example flow diagram illustrating option 3A where a partial request for a missing segment leads to a request for the whole segment over unicast.

FIG. 18 is an example flow diagram illustrating option 3B where a partial request (e.g. an HTTP byte range request) leads to a request for the requested portion of a segment over unicast.

FIG. 19 is a flow chart where a unicast fetch support level is determined to be 0 according to a fourth approach.

FIG. 20 is a flow chart where the unicast fetch support level is determined to be 1 according to the fourth approach.

FIG. 21 is a flow chart where the unicast fetch support level is determined to be 2 according to the fourth approach.

FIGS. 22A-22B are example diagrams illustrating interactions between a DASH client, a service layer, and a unicast HTTP server according to a fifth approach.

FIG. 23A is an example time diagram for error detection according to a sixth approach.

FIG. 23B is an example time diagram illustrating repair symbols being fetched proactively according to the sixth approach.

FIG. 24 is an example set of time diagrams 2400 illustrating an algorithm of a hold-and-enable approach of a unicast fetch feature based on gap detection, according to the seventh approach.

FIG. 25 is a time diagram illustrating an excessive unicast delay.

FIG. 26 is an example time diagram illustrating aborting of fetching in case of an excessive unicast delay, according to an eighth approach.

FIG. 27 is a flow chart of a method of wireless communication.

FIGS. 28A-28C are flow charts of a method of wireless communication expanding from FIG. 27.

FIGS. 29A and 29B are flow charts of a method of wireless communication expanding from FIG. 27.

FIGS. 30A and 30B are flow charts of a method of wireless communication expanding from FIG. 27.

FIGS. 31A-31D are flow charts of a method of wireless communication expanding from FIG. 27.

FIG. 32 is a flow chart of a method of wireless communication expanding from FIG. 27.

FIG. 33 is a conceptual data flow diagram illustrating the data flow between different modules/means/components in an exemplary apparatus.

FIG. 34 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

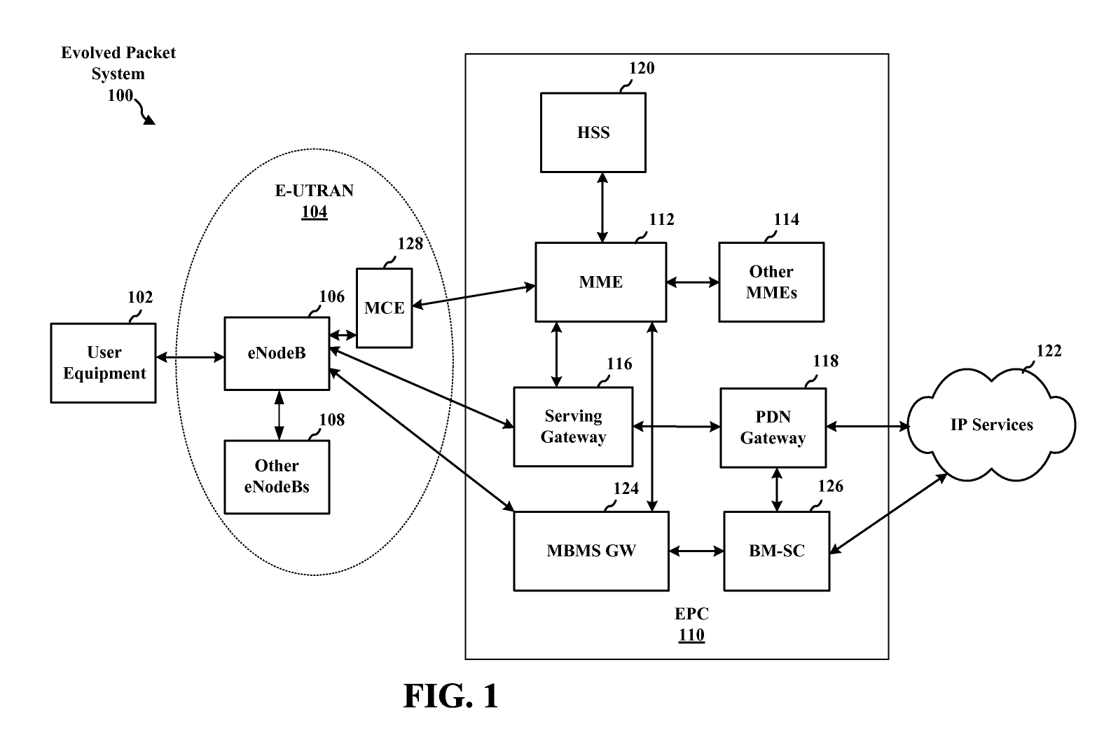

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

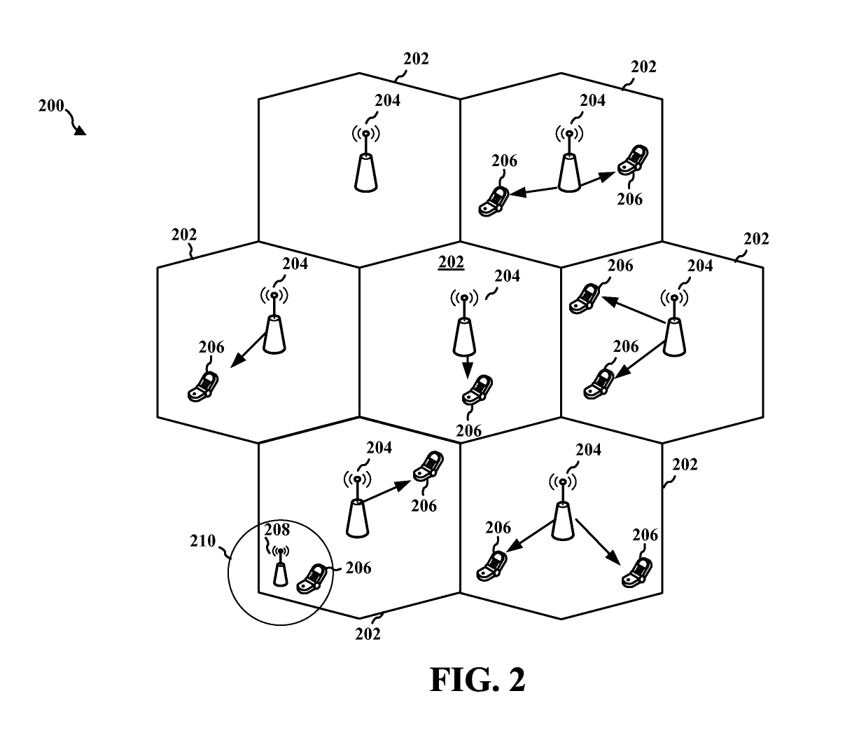

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

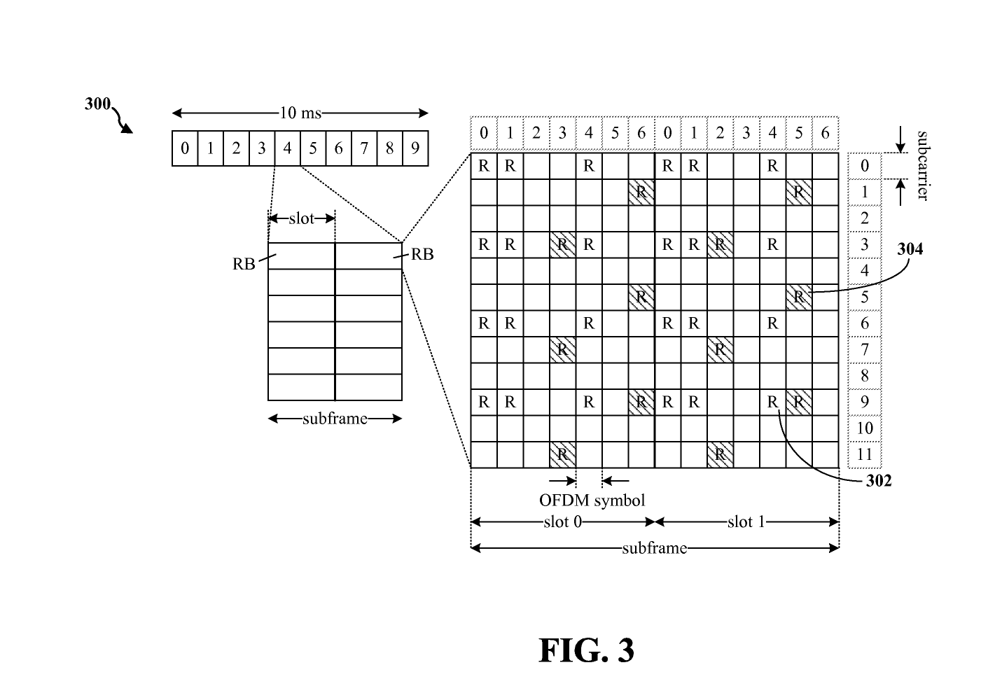

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block may contain 12 consecutive subcarriers in the frequency domain and, for a normal cyclic prefix in each OFDM symbol, 7 consecutive OFDM symbols in the time domain, or 84 resource elements. For an extended cyclic prefix, a resource block may contain 6 consecutive OFDM symbols in the time domain, or 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

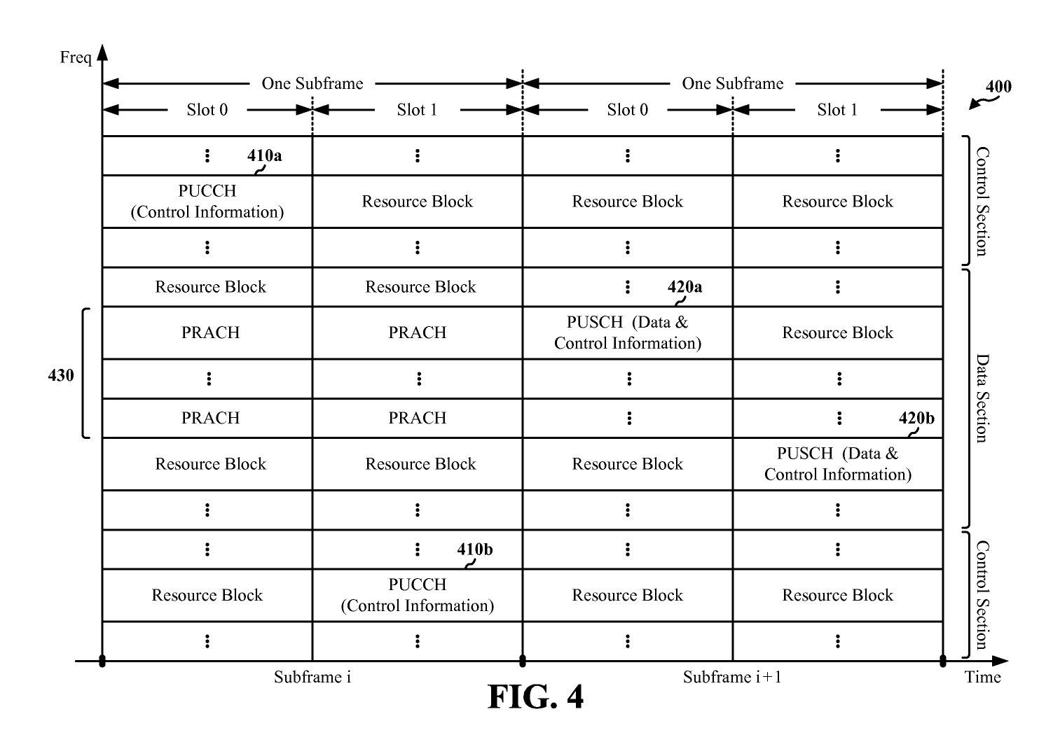

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

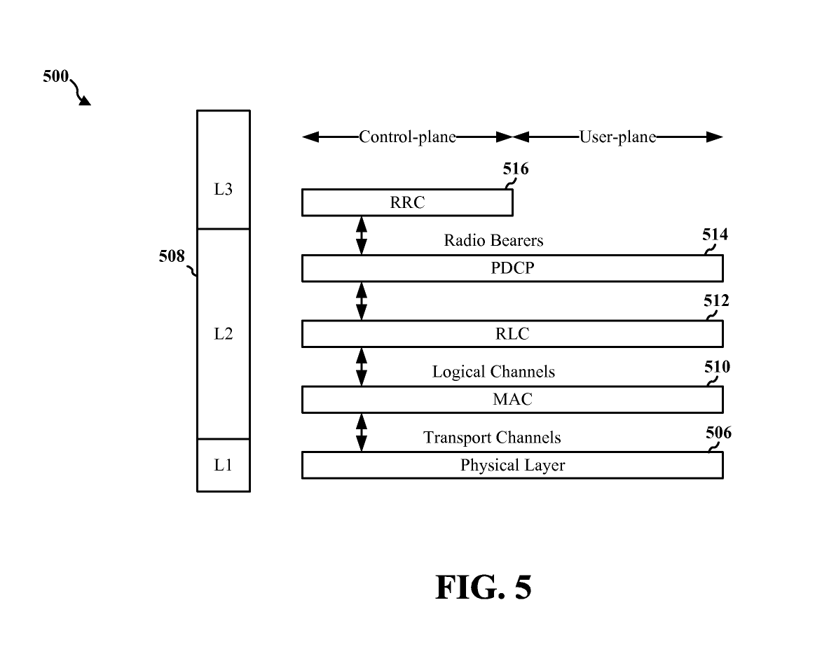

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

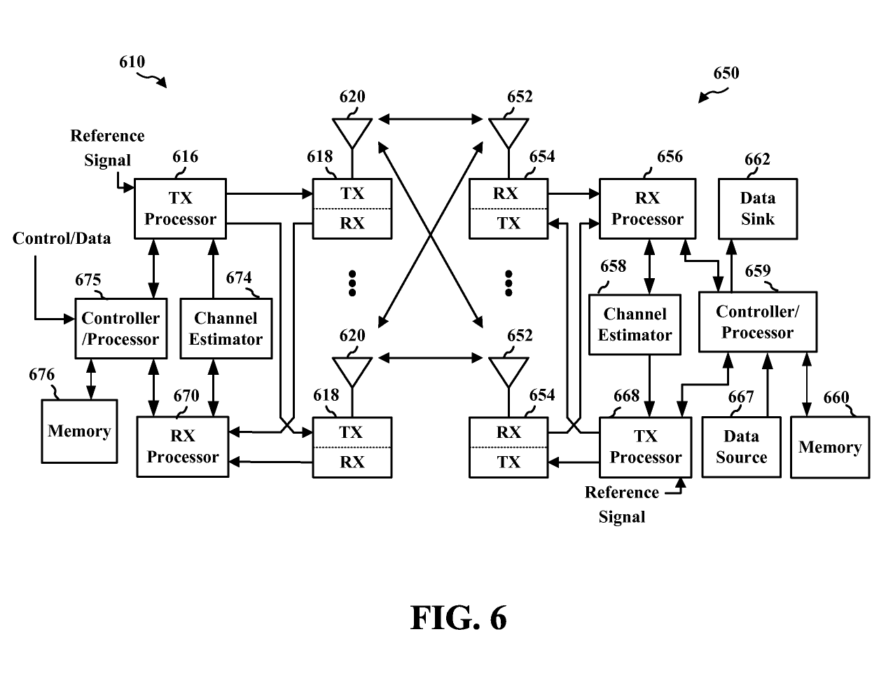

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

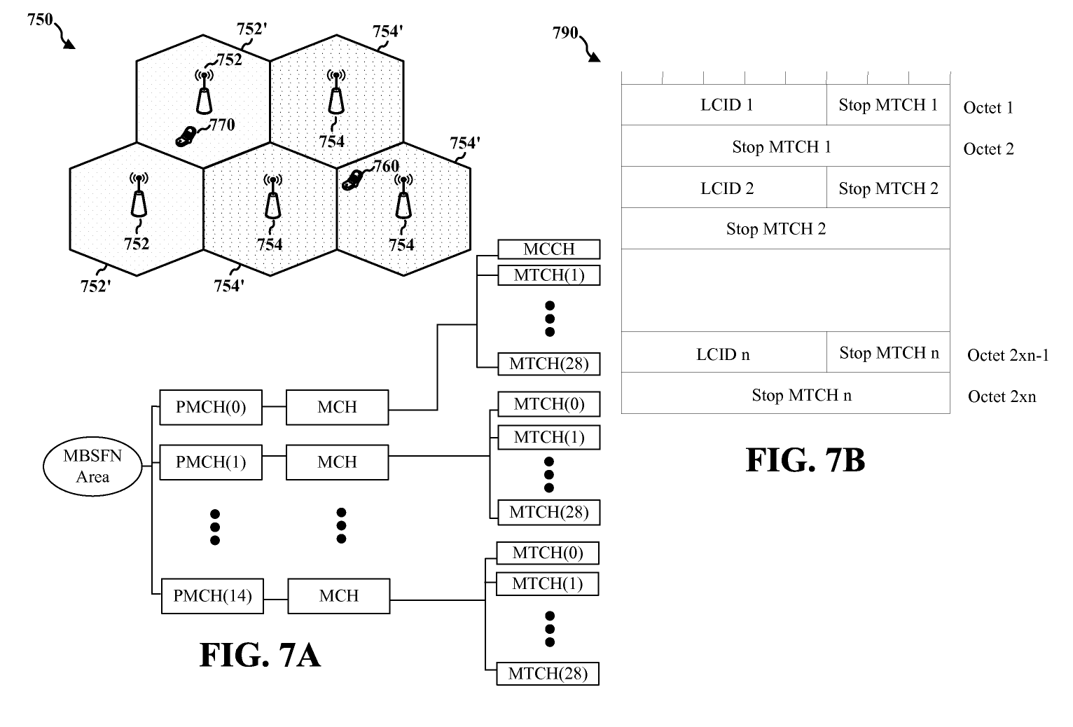

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 may indicate (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

A server may stream data over hypertext transfer protocol (HTTP). Dynamic Adaptive Streaming over HTTP (DASH) enables streaming content of a service over HTTP to the UE. DASH formatted content may be streamed over eMBMS, and may be streamed in multiple segments. However, if the UE is activated to receive an eMBMS service via DASH, the UE may not be able to receive a current segment broadcasted at the time of the UE activation, and may start receiving segments after the current segment. Because the UE may not be able to successfully receive the currently broadcasted segment at the time of the UE activation, there may be a delay between the time of the UE activation and actual playback of the broadcasted segments.

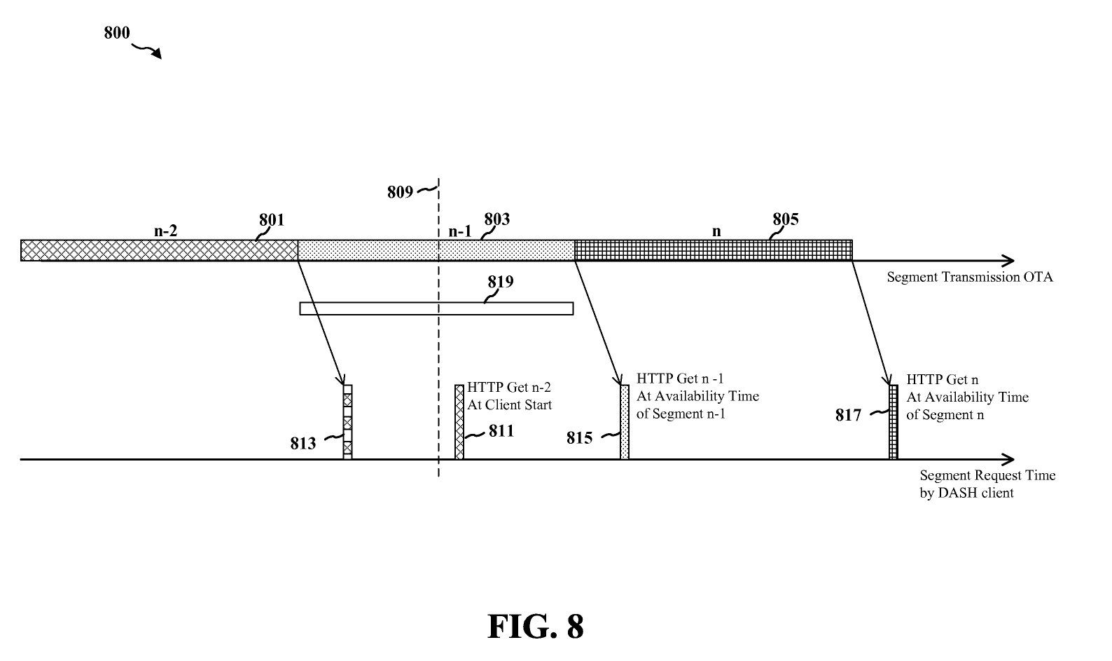

FIG. 8 is an example time diagram 800 for transmitting eMBMS service segments and a segment request time by a DASH client. According to FIG. 8, segments of the eMBMS service such as segment n−2 801, segment n−1 803, and segment n 805 are sequentially broadcasted over the air (OTA). The segments may become available one segment at a time. Note that in practice, data for the segments are broadcasted in bursts according to the MSP parameter associated with each MCH carrying an MTCH which is a bearer of the service. A burst is scheduled at MSP duration for the channel. However, for illustration purposes, the segments are shown as being continuously transmitted over the broadcast channel. Sizes of the segments may vary.

In the example illustrated in FIG. 8, a DASH client is activated at an activation time 809 during the transmission of segment n−1 803. When the DASH client is activated at the activation time 809, a likely DASH client implementation may issue a request 811 to retrieve segment n−2 because segment n−2 is likely to be a currently available segment per the received media presentation description (MPD) for the DASH service. In the example illustrated in FIG. 8, the DASH client cannot retrieve segment n−2 because the segment n−2 was transmitted over the eMBMS service before the UE started receiving the service. It is noted that the segment n−2 would have been retrievable at 813 if the DASH client were activated at an earlier time. The DASH client then issues a request 815 to retrieve segment n−1. Because the DASH client was activated at the activation time 809 during the transmission of segment n−1, the DASH client may not be able to recover segment n−1 using the packets and symbols received for segment n−1. For example, the activation time 809 of the DASH client may not be early enough during the transmission of segment n−1 to successfully receive enough packets of segment n−1 in order to reconstruct segment n−1 via forward error correction. After transmitting the request 815 to retrieve segment n−1, the DASH client issues a request 817 to retrieve segment n 805. Because the DASH client was already activated before the beginning of the transmission of segment n 805, the DASH client can fully retrieve segment n 805 (except if reception errors prevent a successful recovery of the segment, for example). Thus, even if the DASH client is activated during the transmission of segment n−1 803, a playback of the service may begin with segment n 805 upon the request 817 after the OTA transmission of segment n 805. For example, if the DASH client is activated during a time period 819, where the time period 819 is the time after the beginning of the OTA transmission of segment n−1 803 and before the OTA transmission of segment n 805, the playback of the service may begin with segment n. After activation of the DASH client, the DASH client may take up to two segment durations (e.g., segment n−1 803 and segment n 805) to start playback of eMBMS service segments. The request to retrieve a segment may be an HTTP request. Retrieving a segment via the HTTP request may be made in two steps, where the first step is a request to obtain a first part of the segment containing a SegmentIndexBox (sidx), and the second step is a request to obtain the rest of the segment.

The examples provided in FIG. 8 and on illustrate a DASH service that plays a single representation. However, the same algorithms are applicable if multiple representations must be received (e.g., one audio representation and one video representation). In such a case, the n^{th} segment may be replaced by an n^{th} audio segment and an n^{th} video segment and the algorithms shown herein are applied to the audio and video representations.

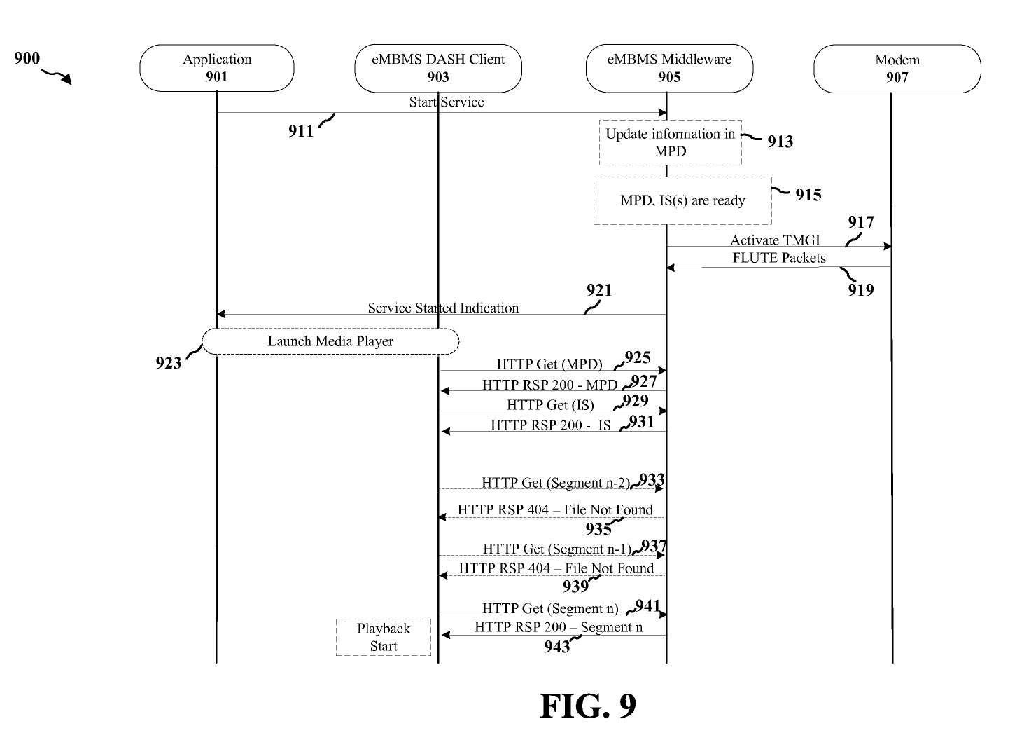

FIG. 9 is an example flow diagram 900 illustrating a playback process of an eMBMS service. The flow diagram 900 includes an application 901, an eMBMS DASH client 903, an eMBMS middleware 905, and a modem 907. The application 901, the eMBMS DASH client 903, the eMBMS middleware 905, and the modem 907 may be included in the UE. The eMBMS middleware 905 may include a local HTTP server that receives segments of an eMBMS service and makes the received segments available in the local HTTP server. At 911, the application 901 sends a start service request to the eMBMS middleware 905. At 913, the eMBMS middleware 905 updates URLs, time-shift buffer depth, and availability time in an MPD that is locally stored. The MPD contains information that the eMBMS DASH client 903 can access to determine where to retrieve the segments (e.g., from a local HTTP server of the eMBMS middleware 905). At 915, the MPD and initialization segments (ISs) are ready to be provided to the eMBMS DASH client 903.

Optionally, when the MPD and initialization segments (ISs) become ready at 915, eMBMS middleware 905 may send a service initiated indication to the application 901 such that the application 901 can launch a media player upon receiving the service initiated indication, where the media player is interfaced with the eMBMS DASH client 903. At 917, the eMBMS middleware 905 transmits a TMGI activation request to the modem 907. In response, at 919, the modem 907 sends file delivery over unidirectional transport (FLUTE) packets to the eMBMS middleware 905 in order to set up a protocol for delivery of data over the Internet. When the eMBMS middleware 905 receives at least one segment (e.g., segment n) through broadcast of the eMBMS service, the eMBMS middleware 905 sends a service initiation indication to the application 901 at 921. In the example illustrated in FIG. 8, the first segment to be received is segment n, and thus when the eMBMS middleware 905 receives segment n, the eMBMS middleware 905 sends the service initiation indication to the application 901. At 923, upon receiving the service initiation indication, the application 901 launches a media player, which activates the eMBMS DASH client 903. At 925, the eMBMS DASH client 903 sends an HTTP GET request for the MPD, and at 927, the eMBMS DASH client 903 successfully receives the MPD with an HTTP response code 200. At 929, the eMBMS DASH client 903 sends an HTTP GET request for an initialization segment (IS), and at 931, the eMBMS DASH client 903 successfully receives the IS with an HTTP response code 200.

Subsequently, a segment request is transmitted depending on timing and a DASH client implementation. According to the example illustrated in FIG. 8, the eMBMS DASH client 903 is activated during segment n−1. Thus, when the eMBMS DASH client 903 sends an HTTP GET request for segment n−2 at 933, the eMBMS DASH client 903 receives a “File Not Found” message with an HTTP response code 404 at 935. When the eMBMS DASH client 903 sends an HTTP GET request for segment n−1 at 937, the eMBMS DASH client 903 receives a “File Not Found” message with an HTTP response code 404 at 939. When the eMBMS DASH client 903 sends an HTTP GET request for segment n at 941, the eMBMS DASH client 903 receives segment n with an HTTP response code 200 at 943. When the eMBMS DASH client 903 receives segment n, the eMBMS DASH client 903 starts playback of segment n, which is the first downloaded segment in the example illustrated in FIG. 9.

The initial acquisition time is generally no less than a duration of a segment (e.g., SegmentDuration) and may be as large as approximately 2*SegmentDuration. In the example illustrated in FIG. 8, if the activation time 809 is closer to the beginning of the OTA transmission of segment n−1, the initial acquisition time may be close to 2*SegmentDuration (e.g., the duration of segment n−1 and segment n). If the activation time 809 is closer to the end of the OTA transmission of segment n−1, the initial acquisition time may be close to SegmentDuration (e.g., the duration of segment n). Generally, an average initial acquisition time is approximately 1.5*SegmentDuration. For a segment with a large segment size having a long SegmentDuration (e.g., 6 seconds), the initial acquisition time is no less than 6 seconds and may be as large as approximately 12 seconds. Hence, if large segments are used, then an initial acquisition time may be large. Note that additional startup delay may be incurred if the segment does not include an I-frame (a self contained video frame, e.g., an intra-coded frame), or if the availability time is set with too large a margin causing the DASH client to issue a request to retrieve the segment later than necessary.

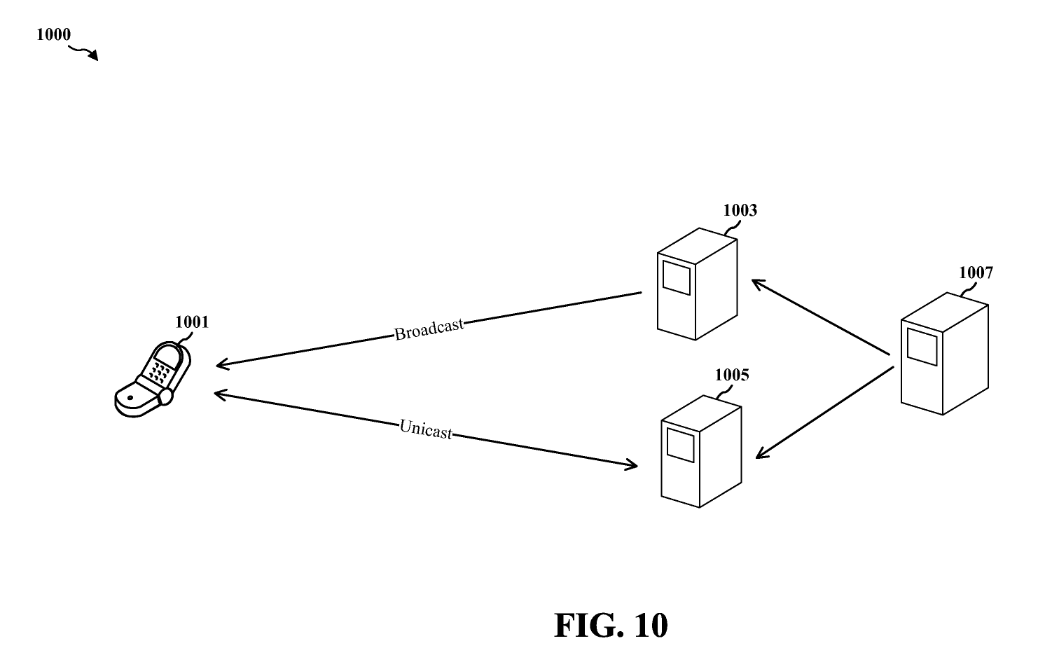

According to an embodiment, acquisition of the first few segments through unicast may reduce initial playback delays after the UE activation. Thus, when the UE is activated, the UE may retrieve the first few segments over unicast, and then retrieve later segments over broadcast. FIG. 10 is an example system 1000 for DASH segment playback according to an embodiment. The system 1000 includes a UE 1001, a broadcast multicast serving center (BMSC) 1003, a unicast DASH server 1005, and a DASH encoder 1007 that communicate with one another. As discussed supra, the UE 1001 may include a DASH client and an eMBMS middleware. The UE 1001 and the DASH encoder 1007 are available for both broadcast and unicast. The BMSC 1003 receives segments from the DASH encoder 1007 and places the segments on a bearer such that the segments may be delivered to various devices such as the UE 1001 over broadcast. The unicast DASH server 1005 receives segments from the DASH encoder 1007 such that the UE 1001 may request the unicast DASH server 1005 for the segments over unicast and receive the segments from the unicast DASH server 1005 over unicast. The MPD in the user service description (USD) received from the BMSC 1003 and the unicast DASH server 1005 can be used to access broadcast DASH segments and unicast DASH segments. The same URL may be used to tag segments received over broadcast using the FLUTE protocol and to request the segments over unicast. In another embodiment, the UE may use a file repair procedure in an eMBMS to recover a missing file by recovering a full file or encoded symbols of the file as needed.

Segments may be available on the unicast DASH server 1005 for unicast at or prior to a time when the segments are available over broadcast. Thus, upon activation of the DASH client in the UE 1001, if the middleware of the UE 1001 determines that the first few segments are not available at the middleware, the middleware of the UE 1001 may fetch a first few segments over unicast, and then fetch the remaining segments over broadcast.

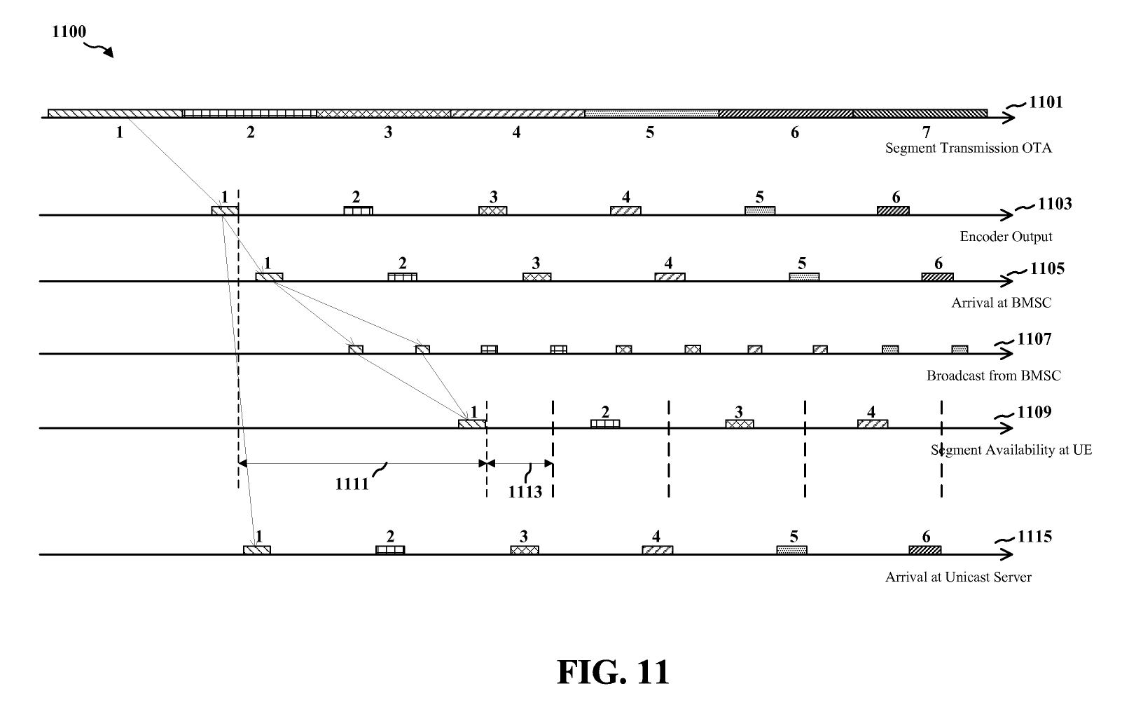

FIG. 11 is an example set of time diagrams 1100 illustrating a broadcast delay and a unicast delay. A segment transmission diagram 1101 illustrates that segments 1-7 are transmitted over the air. An encoder output diagram 1103 illustrates that encoded segments 1-6 are output from an encoder. A BMSC arrival time diagram 1105 illustrates that the encoded segments 1-6 arrive from the encoder. A broadcast time diagram 1107 illustrates that fragments of the encoded segments 1-6 are broadcasted. A segment availability time diagram 1109 illustrates that the broadcasted fragments are received and processed to reconstruct encoded segments 1-4 (encoded segments 5 and 6 not shown). The segment available time diagram 1109 also illustrates an actual delivery delay 1111 for segment 1, and a margin 1113 for a worst possible delay. A unicast server arrival time diagram 1115 illustrates encoded segments 1-6 arrived at a unicast server. The availability time in the MPD may indicate segment availability through broadcast. As illustrated in FIG. 11, the segments are available at an earlier time at the unicast server than at the BMSC. However, because the delivery time from the broadcast server to the client is shorter than the delivery time from the unicast server to the client, the client may not necessarily receive the unicast transmission earlier than the broadcast transmission. Furthermore, a unicast service is usually provided through Content Delivery Networks (CDNs) which include their own scheduling and setup delay for content delivery. Thus, the unicast delay may be more than the broadcast delay. However, even in this case, it may be possible to delay the broadcast of segments to ensure segment availability at the Unicast CDN servers ahead of the availability of segments at the UE through broadcast.

There are various approaches to improve user experience of the eMBMS service. A first approach provides several options to fetch initial segments, including options 1A, 1B and 1C. Option 1A is a pro-active fetch approach, where a middleware determines segments to fetch before receiving a fetch request. Thus, according to option 1A, the middleware may fetch the segments before or after receiving a fetch request. The middleware may be a multicast service device client (MSDC). For example, the middleware may parse the MPD, and determine whether a next segment should be fetched (e.g., segment n−2) over unicast based on various factors such as a template and current time. If the middleware determines that the next segment should be fetched over unicast, the middleware determines universal resource indicators (URIs) of the segments to be fetched, and then fetches the segments using the URIs. For example, when the DASH client is activated, the middleware may determine to fetch segment n−2 and segment n−1 (e.g., over unicast) before receiving a request to retrieve any segment. In an aspect, the fetching of segment n−2 may not be completed before the DASH client transmits a request to retrieve segment n−2.

Option 1B is a reactive approach, where the middleware fetches segments upon receiving a fetch request. For example, for the first two segments after activating the DASH client, the local HTTP server in the eMBMS middleware receives a request for a segment and fetches the segment from a unicast server through unicast. The request may be an HTTP get request identified by a requested base part of a URI corresponding to the requested segment. The middleware may change the requested URI in order to direct the request for the segment to the unicast server that is located away from the middleware, instead of utilizing the local server within the middleware. Option 1C may be a combination of option 1A and option 1B. For example, the middleware may utilize the proactive approach according to option 1A to fetch the first segment and may utilize the reactive approach according to option 1B to fetch the second segment. Option 1A and option 1B may have a similar response latency because unicast round trip delays are generally low in LTE networks.

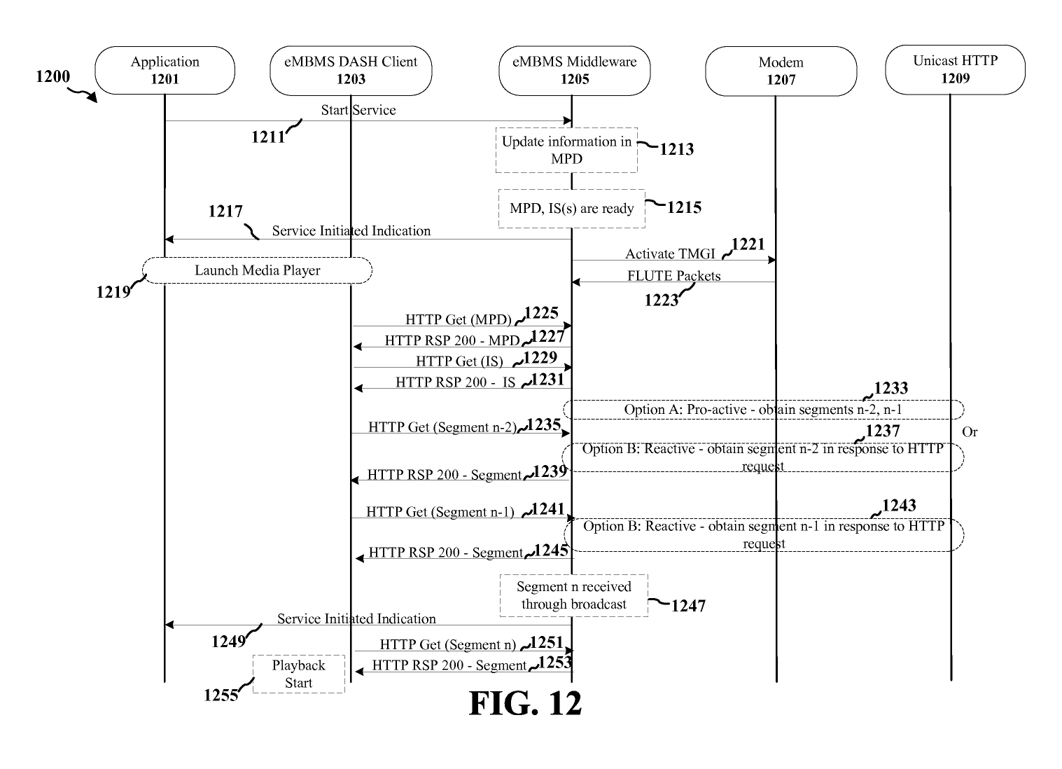

FIG. 12 is an example flow diagram 1200 illustrating a playback process of an eMBMS service according to the first approach. The flow diagram 1200 includes an application 1201, an eMBMS DASH client 1203, an eMBMS middleware 1205, a modem 1207, and a unicast server 1209. The eMBMS middleware 1205 may include a local HTTP server that receives segments of an eMBMS service and makes the received segments available at the local HTTP server. At 1211, the application 1201 sends a start service request to the eMBMS middleware 1205. At 1213, the eMBMS middleware 1205 updates URLs, time-shift buffer depth, and availability time in an MPD that is locally stored. The MPD allow the eMBMS DASH client 1203 to know where to retrieve the segments (e.g., from a local HTTP server of the eMBMS middleware 1205). At 1215, the MPD and ISs are ready to be provided to the eMBMS DASH client 1203. At 1217, the eMBMS middleware 1205 sends a service initiated indication to the application 1201, and at 1219, the application 1201 launches a media player upon receiving the service initiated indication, where the media player interfaces with the eMBMS DASH client 1203. The launching of the media player at 1219 activates the eMBMS DASH client 1203. Further, when the eMBMS DASH client 1203 is activated, the eMBMS middleware 1205 transmits at 1221 a TMGI activation request to the modem 1207. In response, at 1223, the modem 1207 sends FLUTE packets to the eMBMS middleware 1205. At 1225, the eMBMS DASH client 1203 sends an HTTP GET request for the MPD, and at 1227, the eMBMS DASH client 1203 successfully receives the MPD with an HTTP response code 200. At 1229, the eMBMS DASH client 1203 sends an HTTP GET request for an IS, and at 1231, the eMBMS DASH client 1203 successfully receives the IS with an HTTP response code 200.

If the eMBMS middleware 1205 utilizes option 1A, then at 1233, the eMBMS middleware 1205 obtains segment n−2 and segment n−1 from the unicast server 1209 over unicast, before receiving a request for segment n−2 or segment n−1. However, if option 1A is not utilized, the eMBMS middleware 1205 does not retrieve any segment without a request for a segment, and thus does not retrieve any segments at 1233. At 1235, eMBMS DASH client 1203 sends an HTTP GET request for segment n−2 to the eMBMS middleware 1205. If option 1B is utilized, then at 1237, the eMBMS middleware 1205 obtains segment n−2 from the unicast server 1209 over unicast in response to the HTTP GET request, and subsequently sends the eMBMS DASH client 1203 an HTTP response code 200 for successfully retrieving a segment at 1239. Then, the media player may play segment n−2 retrieved from the unicast server 1209. At 1241, the eMBMS DASH client 1203 sends an HTTP GET request for segment n−1 to the eMBMS middleware 1205. If option 1B is utilized, then at 1243, the eMBMS middleware 1205 obtains segment n−1 from the unicast server 1209 over unicast in response to the HTTP GET request, and subsequently sends the eMBMS DASH client 1203 an HTTP response code 200 for successfully retrieving a segment at 1245. Then, the media player may play segment n−1.

After receiving segment n−2 and segment n−1 over unicast, the eMBMS middleware 1205 receives segment n over broadcast at 1247. Thus, the eMBMS middleware 1205 may retrieve segment n−2 and segment n−1 over unicast, and may retrieve segment n and later segments over broadcast. When the eMBMS middleware 1205 receives segment n, the eMBMS middleware 1205 sends a service initiated indication to the application 1201 at 1249. At 1251, the eMBMS DASH client 1203 sends an HTTP GET request for segment n to the eMBMS middleware 1205. In response, at 1253, the eMBMS DASH client 120 sends the eMBMS DASH client 1203 an HTTP response code 200 for successfully receiving segment n. The media player starts playing back segment n at 1255 after receiving the HTTP response code 200.

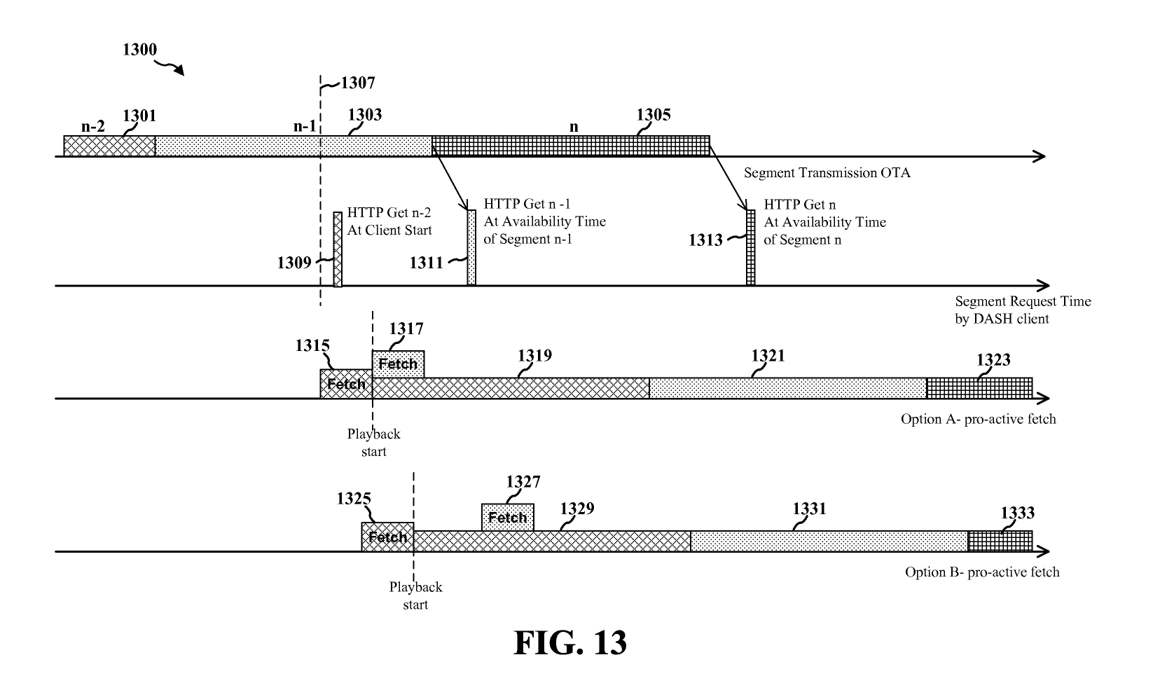

FIG. 13 is an example time diagram 1300 for transmitting eMBMS service segments and a segment request time by a DASH client, illustrating playback of option 1A and playback of option 1B according to the first approach. According to FIG. 13, the eMBMS service segments such as segment n−2 1301, segment n−1 1303, and segment n 1305 are sequentially transmitted over the air. In the example illustrated in FIG. 13, a DASH client is activated at activation time 1307 during transmission of segment n−1 1303. After the DASH client is activated at the activation time 1307, the DASH client transmits to the middleware a request 1309 to retrieve segment n−2. Later in time, the DASH client transmits to the middleware a request 1311 to retrieve segment n−1, and a request 1313 to retrieve segment n. As illustrated in the example of FIG. 12, segment n−2 and segment n−1 may be received over unicast, and segment n may be received over broadcast. If option 1A is utilized (proactive fetch), the middleware starts fetching segment n−2 at 1315 shortly after the activation time 1307 and prior to receiving the request 1309 to retrieve segment n−2 from the unicast server. The middleware then fetches segment n−1 at 1317 after fetching segment n−2 and before receiving the request 1311 to retrieve segment n−1 from the unicast server. After fetching of segment n−2 at 1315 is completed, the DASH client performs playback of segment n−2 1319. After fetching of segment n−1 at 1317 is completed, the DASH client performs playback of segment n−1 1321 after the playback of segment n−2 1319 and subsequently performs playback of segment n 1323. It is noted that, in the example illustrated in FIG. 13, the fetching 1315 of segment n−2 may not be completed before the DASH client transmits the request 1309 to retrieve segment n−2.

If option 1B is utilized (reactive fetch), the middleware fetches segment n−2 at 1325 after the DASH client transmits the request 1309 to retrieve segment n−2 from the unicast server. After fetching of segment n−2 at 1325 is completed, the middleware fetches segment n−1 at 1327 after receiving the request 1311 to retrieve segment n−1 from the unicast server. After fetching of segment n−2 at 1325 is completed, the DASH client performs playback of segment n−2 1329. After fetching of segment n−1 at 1327 is completed, the DASH client performs playback of segment n−1 1331 after the playback of segment n−2 1319 and subsequently performs playback of segment n 1333.

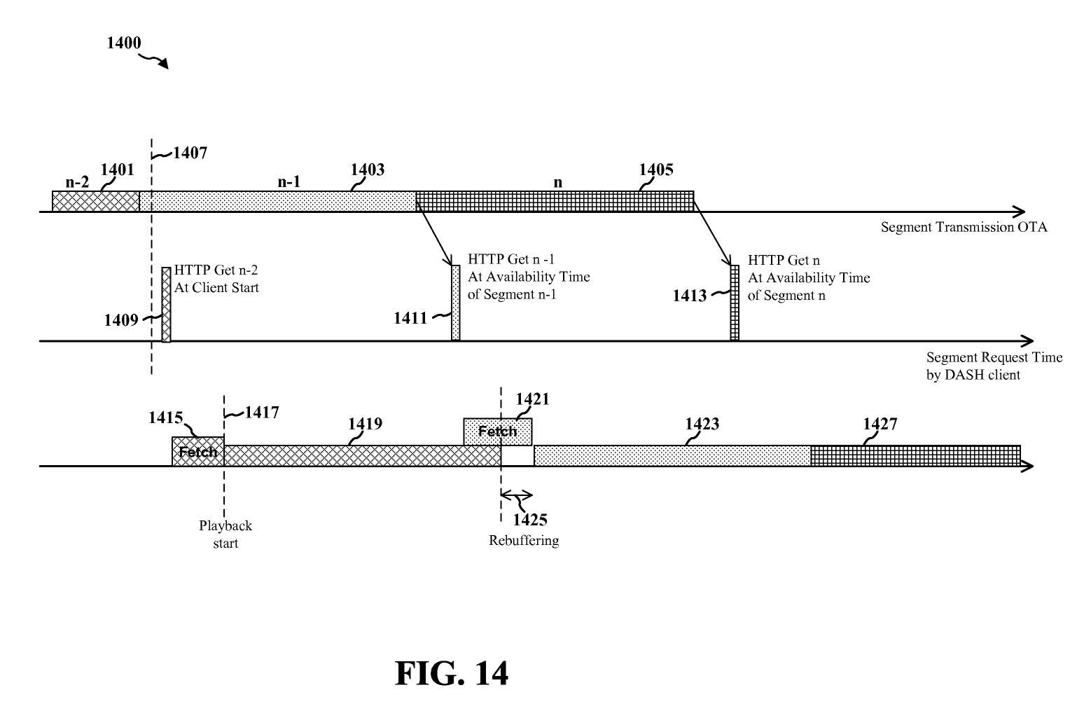

FIG. 14 an example time diagram 1300 for transmitting eMBMS service segments and a segment request time by a DASH client, illustrating a corner case for option 1B according to the first approach. According to FIG. 14, eMBMS service segments such as segment n−2 1401, segment n−1 1403, and segment n 1405 are sequentially transmitted over the air. In the example of the corner case illustrated in FIG. 14, a DASH client is activated at an activation time 1407 that is near a start time of OTA transmission of segment n−1 1403. After the DASH client is activated at the activation time 1407, the DASH client transmits to the middleware a request 1409 to retrieve segment n−2. Later in time, the DASH client transmits to the middleware a request 1411 to retrieve segment n−1, and a request 1413 to retrieve segment n. In response to the request 1409 to retrieve segment n−2, fetching 1415 of segment n−2 is performed. Subsequently, at a time line 1417, playback begins with playback of segment n−2 1419. Near the end of playback of segment n−2 1419, the middleware performs fetching 1421 in response to the request 1411 to retrieve segment n−1. In the corner case where the activation time 1407 is near the start time of OTA transmission of segment n−1 1403, if the fetching 1421 of segment n−1 is not completed for an extended period of time, then re-buffering of segment n−2 may occur to play a portion of segment n−2 because the middleware cannot perform playback of segment n−1 during a re-buffering period 1425. The re-buffering of segment n−2 during the re-buffering period 1425 may freeze the playback to a frame of segment n−2. For example, if segment n−1 is large or if unicast bandwidth reduces between the fetches for segments n−2 and n−1 or if there are other transient errors, the fetching 1421 of segment n−1 may not be completed for an extended period of time, causing the duration of the fetching 1421 of segment n−1 to extend beyond the playback of segment n−2 1419. Hence, option 1A may be preferred and thus selected over option 1B if the fetching of a segment is expected to take an extended period of time. For example, the UE may be configured to utilize option 1A instead of option 1B if the fetching of a segment is expected to take an extended period of time. When the fetching 1421 of segment n−1 is completed, the playback of segment n−1 1423 is performed. Further, in response to the request 1413 to retrieve segment n, playback of the segment n 1427 is performed.

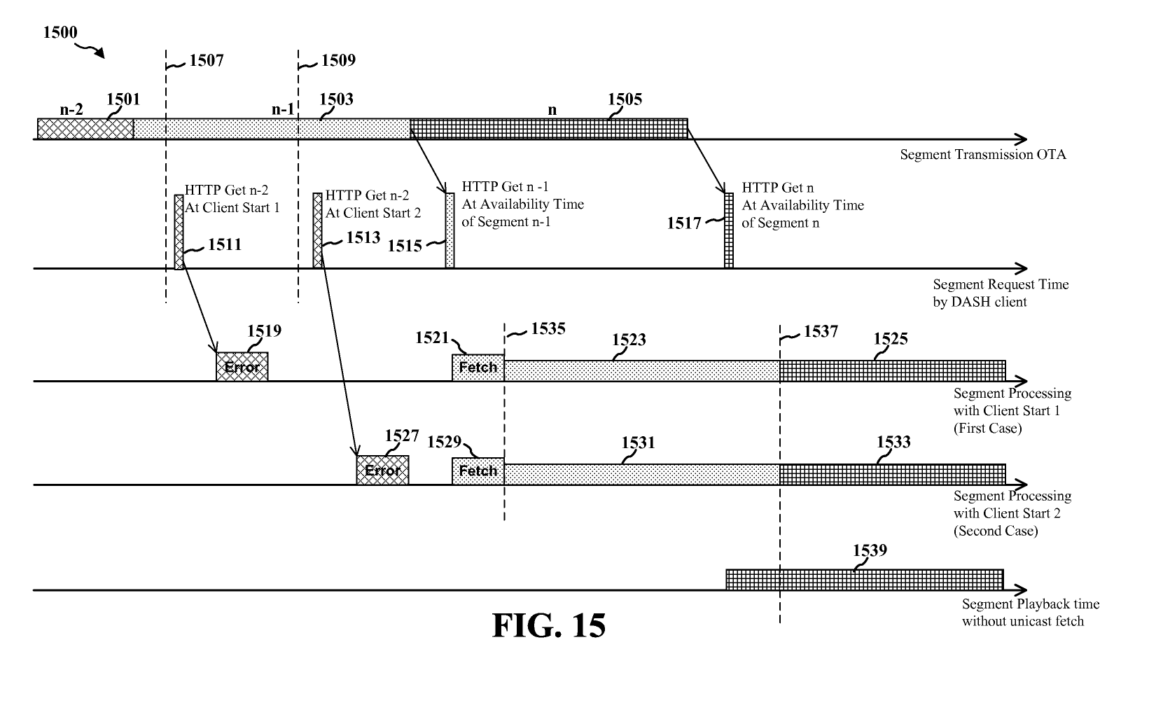

According to a second approach, upon activation of the DASH client, there may be two options with regard to fetching the first two segments after the activation of the DASH client. Option 2A allows fetching the latter of the first two segments over unicast. Option 2B allows fetching the first two segments over unicast. FIG. 15 is an example time diagram 1500 of option 2A according to the second approach, where one of two segments is fetched over unicast. According to FIG. 15, the eMBMS service segments such as segment n−2 1501 and segment n−1 1503 are sequentially transmitted over the air via unicast. Segment n 1505 is then transmitted over the air via broadcast. FIG. 15 illustrates two activation times of the DASH client for two separate devices, a first activation time 1507 of a first UE and a second activation time 1509 of a second UE. Thus, to retrieve segment n−2, the DASH client transmits a request 1511 if the DASH client is activated at the first activation time 1507, and the DASH client transmits a request 1513 if the DASH client is activated at the second activation time 1509. Regardless of whether the DASH client is activated at the first activation time 1507 or at the second activation time 1509, the DASH client transmits a request 1515 to retrieve segment n−1, and also transmits a request 1517 to retrieve segment n. According to option 2A, segment n−1 is fetched, but segment n−2 is not fetched.

For the first UE with the first activation time 1507, when the DASH client transmits the request 1511 to retrieve segment n−2, the DASH client receives an error response 1519 because segment n−2 cannot be fetched according to option 2A. When the DASH client transmits the request 1515 to retrieve segment n−1, the middleware performs a fetch 1521 of segment n−1 over unicast, and the DASH client subsequently performs segment n−1 playback 1523. After the segment n−1 playback 1523, the DASH client performs segment n playback 1525. For the second UE with the second activation time 1509, when the DASH client transmits the request 1513 to retrieve segment n−2, the DASH client receives an error response 1527 because segment n−2 cannot be fetched according to option 2A. When the DASH client transmits the request 1515 to retrieve segment n−1, the middleware performs a fetch 1529 of segment n−1 over unicast, and the DASH client subsequently performs segment n−1 playback 1531. After the segment n−1 playback 1531, the DASH client performs segment n playback 1533. Although the DASH client is activated at different activation times for the first UE and the second UE, the segment n−1 playback 1523 of the first UE and the segment n−1 playback 1531 of the second UE start at the same start time line 1535, and the segment n playback 1525 of the first case and the segment n playback 1533 of the second case start at the same start time 1537. It is also noted that, if there is no unicast fetch and thus neither segment n−2 nor segment n−1 is retrieved over unicast, segment n playback 1539 occurs earlier than the start time 1537 of the segment n playback for the first UE and the second UE (e.g., upon the request 1517 to retrieve segment n) because the segment n playback 1539 is not delayed by playback of segment n−1 or segment n−2.

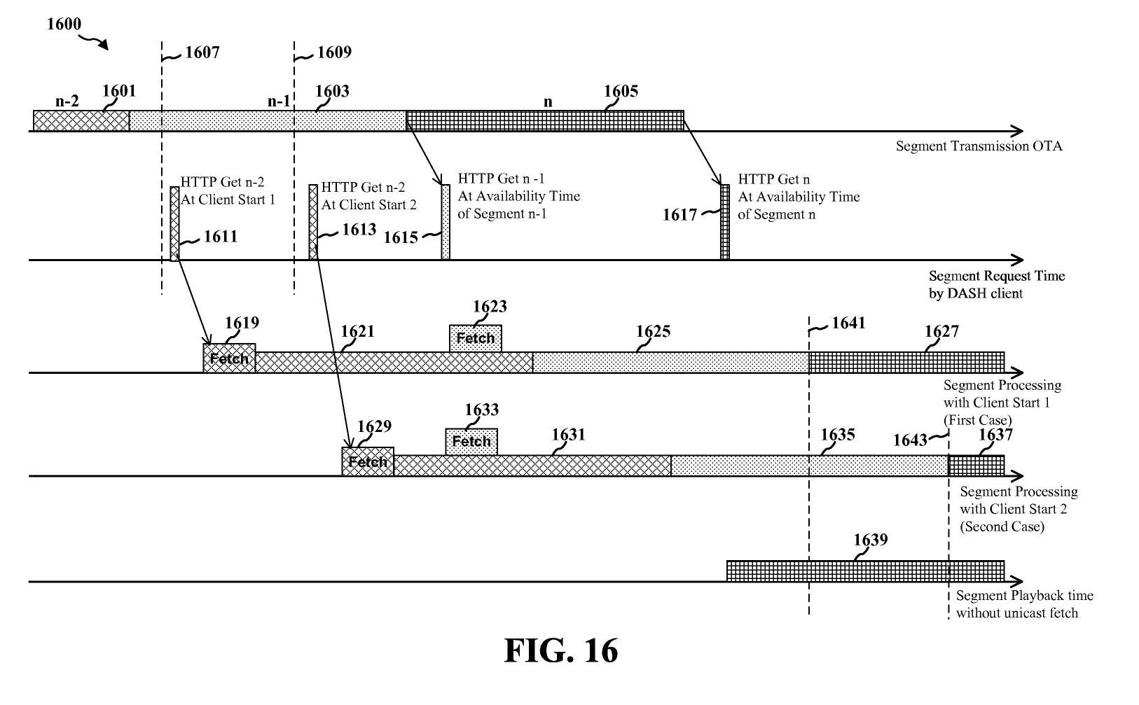

FIG. 16 is an example time diagram 1600 of option 2B according to the second approach where two segments are fetched over unicast. According to FIG. 15, eMBMS service segments such as segment n−2 1601 segment n−1 1603 are sequentially transmitted over the air via unicast. Segment n 1605 is then transmitted over the air via broadcast. FIG. 16 illustrates two activation times of the DASH clients for two separate devices, a first activation time 1607 for a first UE and a second activation time 1609 for a second UE. Thus, to retrieve segment n−2, the DASH client of the first UE transmits a request 1611 if the DASH client of the first UE is activated at the first activation time 1607, and the DASH client of the second UE transmits a request 1613 if the DASH client of the second UE is activated at the second activation time 1609. Regardless of whether the DASH client is activated at the first activation time 1607 or at the second activation time 1609, the DASH client transmits a request 1615 to retrieve segment n−1, and also transmits a request 1617 to retrieve segment n. According to option 2B, both segment n−1 and segment n−2 may be fetched over unicast.

For the first UE with the first activation time 1607, when the DASH client transmits the request 1611 to retrieve segment n−2, the middleware performs a fetch 1619 for segment n−2. After the fetch 1619 for segment n−2, the DASH client performs segment n−2 playback 1621. In response to the request 1615 to retrieve segment n−1, the middleware performs a fetch 1623 of segment n−1 over unicast. The DASH client performs segment n−1 playback 1625 after the segment n−2 playback 1621 is completed. Subsequently, the DASH client performs segment n playback 1627. For the second UE with the second activation time 1609, when the DASH client transmits the request 1613 to retrieve segment n−2, the middleware performs a fetch 1629 for segment n−2. After the fetch 1629 for segment n−2, the DASH client performs segment n−2 playback 1631. When the DASH client transmits the request 1615 to retrieve segment n−1, the middleware performs a fetch 1633 of segment n−1 over unicast. The DASH client performs segment n−1 playback 1635 after the segment n−2 playback 1621 is completed. Subsequently, the DASH client performs segment n playback 1637. Because the DASH client of the second UE is activated at a later time than the activation time of the DASH client of the first UE, the segment n−2 playback 1631 of the second case starts at a later time than the segment n−2 playback 1621 of the first case. Thus, the segment n−1 playback 1635 and the segment n playback 1637 of the second UE start at a later time than the segment n−1 playback 1625 and the segment n playback 1627 of the first UE. It is also noted that, if there is no unicast fetch and thus neither segment n−2 nor segment n−1 is retrieved over unicast, segment n playback 1639 occurs earlier than a start time 1641 of the segment n playback 1627 for the first UE and a start time 1643 of the segment n playback 1637 for the second UE (e.g., upon the request 1617 to retrieve segment n).

According to a third approach, each segment may be fetched as a whole (option 3A) or fetched in portions as requested by the DASH client (option 3B). Note that in many instances, a DASH client may request the first part of a segment to read the header information in the segment and decide what portions of the segment should be retrieved. This approach may reduce startup latency, especially if the first I-frame in the first segment is not the first frame in the first segment. Alternatively, the DASH client may always prefer to fetch the header information of the segment to allocate resources and thread activities for the rest of the segment. In option 3A, the middleware may perform one fetch to the unicast server whenever the DASH client issues a request for at least a portion of a segment, thus immediately retrieving the whole segment over unicast. According to option 3B, the middleware may perform one fetch to the unicast server for a first portion (e.g., a first byte range) of a segment to retrieve the first portion of the segment as requested by the DASH client, and then perform another fetch to the unicast server for a second portion (e.g., a second byte range) of the segment to retrieve the second portion as requested by the DASH client. Thus, in option 3B, the middleware is directly relaying HTTP requests from the DASH client directly to the unicast server. Option 3A (whole segment fetch) may be more beneficial for smaller segments than option 3B. Option 3B (segment portions fetched) may be more beneficial for larger segments than option 3A because a large segment may take an extended period of time to fetch and thus may cause delay and fetching portions of the segment may allow the DASH client to start playback faster when the segment is retrieved in portions. Thus, the UE may be configured to select either a whole segment fetch approach or a byte range request approach, based on segment duration of broadcast representation. For example, if the segment size is less than or equal to a threshold segment size, the middleware may fetch the whole segment according to the whole segment fetch approach of option 3A. Otherwise, the middleware may fetch the segment in portions according to the byte range request approach of option 3B.

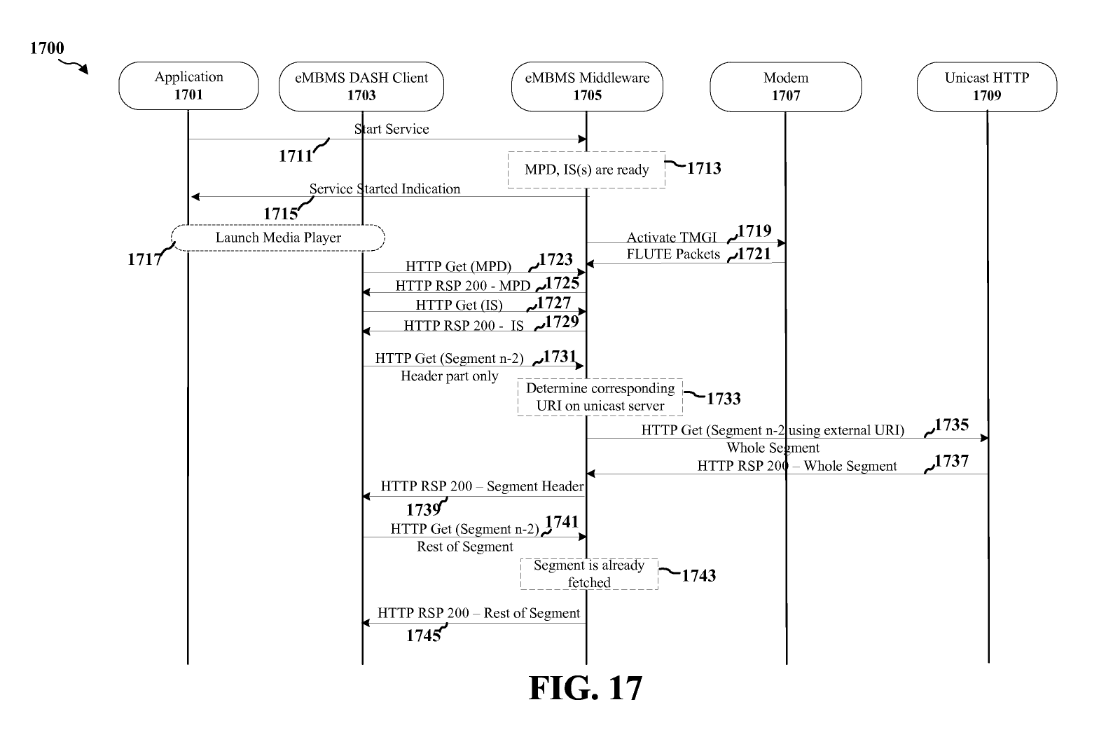

FIG. 17 is an example flow diagram 1700 illustrating a whole segment fetch according to the third approach. The flow diagram 1700 includes an application 1701, an eMBMS DASH client 1703, an eMBMS middleware 1705, a modem 1707, and a unicast server 1709. The eMBMS middleware 1705 may include a local HTTP server that receives eMBMS service segments and makes the received segments available at the local HTTP server. At 1711, the application 1701 sends a start service request to the eMBMS middleware 1705. At 1713, the MPD and ISs are ready to be provided to the eMBMS DASH client 1703. At 1715, the eMBMS middleware 1705 sends a service initiated indication to the application 1701, and at 1717, the application 1701 launches a media player upon receiving the service initiated indication, which activates the eMBMS DASH client 1703. When the eMBMS DASH client 1703 is activated, the eMBMS middleware 1705 transmits at 1719 a TMGI activation request to the modem 1707. In response, at 1721, the modem 1707 sends FLUTE packets to the eMBMS middleware 1705. At 1723, upon activation of the eMBMS DASH client 1703, the eMBMS DASH client 1703 sends an HTTP GET request for the MPD, and at 1725, the eMBMS DASH client 1703 successfully receives the MPD with an HTTP response code 200. At 1727, the eMBMS DASH client 1703 sends an HTTP GET request for an IS, and at 1729, the eMBMS DASH client 1703 successfully receives the IS with an HTTP response code 200.

At 1731, the eMBMS DASH client 1703 sends to the eMBMS middleware 1705 an HTTP GET request for a header portion of segment n−2. The header portion may be the first N bytes, where N is approximately 500. Thus, for example, the HTTP GET request for the header portion of segment n−2 may specify a byte range of 1 through 500 bytes to retrieve the header portion. At 1733, if the eMBMS middleware 1705 is configured to fetch a segment over unicast (e.g., EnableUnicastFetch parameter >0), the eMBMS middleware 1705 determines a URI on the unicast server 1709, where the URI corresponds to the segment to be fetched. Using the URI, the eMBMS middleware 1705 sends an HTTP Get request over unicast to the unicast server 1709 to fetch segment n−2 as a whole, instead of fetching only the header portion of segment n−2. At 1737, the eMBMS middleware 1705 receives from the unicast server 1709 an HTTP response code 200 for successfully fetching segment n−2 as a whole. The eMBMS middleware 1705 subsequently sends the eMBMS DASH client 1703 an HTTP response code 200 for successfully fetching a header part of segment n−2 at 1739. The eMBMS DASH client 1703 sends at 1741 an HTTP GET request for the rest of segment n−2 (e.g., a portion other than the header portion) to the eMBMS middleware 1705. If the header portion consists of the first 500 bytes of the segment, then the HTTP GET request for the rest of segment n−2 may specify a byte range of 501 to the last byte of segment n−2 to retrieve the portion other than the header portion. Because the eMBMS middleware 1705 determines at 1743 that the whole segment is already fetched, the rest of segment n−2 is not fetched from the unicast server 1709, and the eMBMS middleware 1705 sends the eMBMS DASH client 1703 an HTTP response code 200 for successfully fetching the rest of segment n−2 at 1745. It is noted that in option 3A, there is a latency of one round trip delay and a download time for the whole segment n−2 before the segment n−2 is available for playback.

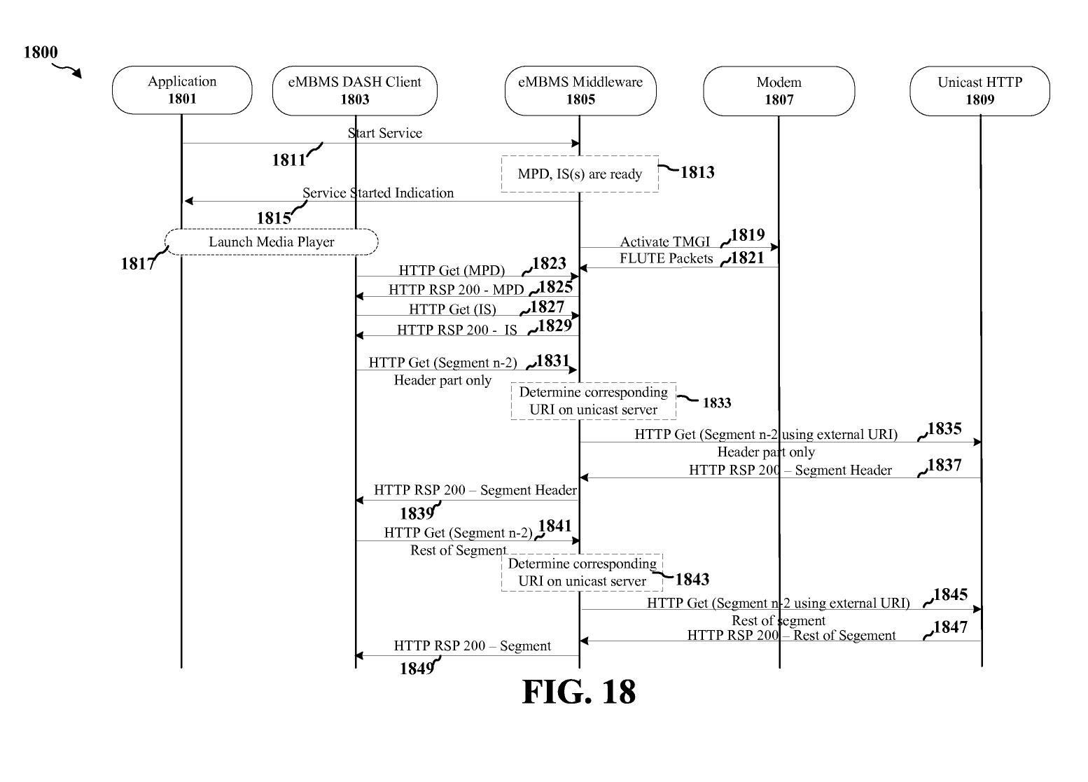

FIG. 18 is an example flow diagram 1800 illustrating option 3B of fetching in portions according to the third approach. The flow diagram 1800 includes an application 1801, an eMBMS DASH client 1803, an eMBMS middleware 1805, a modem 1807, and a unicast server 1809. The eMBMS middleware 1805 may include a local HTTP server that receives eMBMS service segments and makes the received segments available at the local HTTP server. 1811 though 1829 of FIG. 18 are similar to 1711-1729 of FIG. 17, and thus explanations of 1811 through 1829 are omitted for brevity.

At 1831, the eMBMS DASH client 1803 sends to the eMBMS middleware 1805 an HTTP GET request for a header portion of segment n−2. The header portion may be the first N bytes, where N is approximately 500. Thus, for example, the HTTP GET request for the header portion of segment n−2 may specify a byte range of 1 through 500 bytes to retrieve the header portion. At 1833, if the eMBMS middleware 1805 is configured to fetch a segment over unicast (e.g., EnableUnicastFetch parameter >0), the eMBMS middleware 1805 determines a URI on the unicast server 1809, where the URI corresponds to the segment to be fetched. Using the URI, at 1835, the eMBMS middleware 1805 sends an HTTP Get request over unicast to the unicast server 1809 to fetch a header portion of segment n−2. The HTTP Get request to the unicast server 1809 to fetch the header portion may specify a byte range for the header portion of segment n−2 (e.g., 1 through 500 bytes). At 1837, the eMBMS middleware 1805 receives from the unicast server 1809 an HTTP response code 200 for successfully fetching the header portion of segment n−2. The eMBMS middleware 1805 subsequently sends the eMBMS DASH client 1803 an HTTP response code 200 for successfully fetching the header portion of segment n−2 at 1839.

At 1841, the eMBMS DASH client 1803 sends an HTTP GET request for the rest of segment n−2 (e.g., a portion other than the header portion) to the eMBMS middleware 1805. The HTTP GET request for the rest of segment n−2 sent from the eMBMS DASH client 1803 may specify a byte range for the rest of segment n−2 except for the header portion. For example, if the header portion includes the first 500 bytes of the segment, then the HTTP GET request for the rest of segment n−2 may specify a byte range of 501 to the last byte of segment n−2. The eMBMS middleware 1805 determines at 1843 a URI on the unicast server 1809, where the URI corresponds to the segment to be fetched. Using the URI, at 1845, the eMBMS middleware 1805 sends an HTTP Get request over unicast to the unicast server 1809 to fetch the rest of segment n−2. The HTTP Get request to the unicast server 1809 to fetch the rest of segment n−2 may specify the byte range for the rest of segment n−2 except for the header portion. At 1845, the eMBMS middleware 1805 receives from the unicast server 1809 an HTTP response code 200 for successfully fetching the rest of segment n−2. The eMBMS middleware 1805 sends the eMBMS DASH client 1803 an HTTP response code 200 for successfully fetching the rest of segment n−2 at 1849. Thus, in option 3B, there is a latency of two round trip delays and a download time for the header of segment n−2 and the rest of segment n−2 before the segment n−2 is available for playback. For a large segment, it may be beneficial to obtain the segment in portions to expedite an initial acquisition time.

According to a fourth approach, the middleware may control disabling and enabling of the unicast fetch feature. For example, it may be beneficial to disable the unicast fetch feature if the MPD does not point to a valid unicast DASH server and/or when a unicast fetch load is not desirable. An operator-specific provisioning control parameter may be added to control enabling and disabling of the unicast fetch feature. For example, the unicast fetch of the first two requested segments at start-up as previously described may allow faster initial acquisition and a faster start of segment playback, especially if a unicast bandwidth is larger than a broadcast bandwidth. A practical way of implementing this is to enable unicast fetch for a period of 2 segment durations. The unicast fetch for the period of 2 segment durations helps avoid the alternative embodiment of counting 2 segments per representation or counting the total number of requested segments in which case the middleware has prior knowledge of how many representations are present and active for the service. The provisioning control parameter controls the level of support for the unicast fetch feature per device. The middleware may also consider the provisioning parameter to control the unicast fetch feature depending on a service. For example, if the service is provided in a dense venue, unicast fetch may not be desirable due to a potentially large unicast load that the unicast fetch may cause, and thus the middleware may disable the unicast fetch feature. Further, the middleware may consider a service control file to control the unicast fetch feature. If the service control file is not present, then, in one embodiment, the unicast fetch feature may be disabled for all services.

In one example of the provisioning control parameter, the provisioning control parameter enableUnicastFetchForDASH is provided to control the level of support of the unicast fetch feature for a particular UE. An operator controls the provisioning parameter. The provisioning parameter enableUnicastFetchForDASH indicates the level of support of the unicast fetch feature on the device via values 0, 1, and 2. When the provisioning parameter is set to 0, the unicast fetch feature is disabled. When the provisioning parameter is set to 1, the unicast fetch feature is enabled at a beginning (e.g., for a period of 2 segment durations after the start of a service) of the service as long as initial unicast fetch parameter (e.g., unicastFetch) is enabled for the service in the service control file. When the provisioning parameter is set to 2, the unicast fetch feature is enabled at the beginning of the service, and may also be enabled at the end if an incomplete segment is received at the end due to an error in the channel.

As discussed supra, the service control file provides a control for the unicast fetch feature per service. For example, the service control file may provide a list of service IDs (e.g., serviceIDs) and unicast fetch settings (e.g., serviceEnableUnicastFetch). serviceID is a URI that is matched to serviceID in the USD, to identify a service for which the unicast fetch feature is available. The middleware disables the unicast fetch feature for services that do not correspond (e.g., based on the serviceIDs in the USD) with the serviceIDs listed in the service control file. serviceEnableUnicastFetch is a parameter used to control the unicast fetch functionality for a particular service corresponding to serviceID. serviceEnableUnicastFetch may also be set to values 0, 1, and 2.

If the UE does not receive the service control file, the middleware disables the unicast fetch feature for all services. An operator may determine whether to deliver the service control file to the UE. If the UE receives the service control file, then the middleware disables the unicast fetch for services that are not listed in the service control file according to serviceIDs in the service control file. For each service listed in the service control file, the level of unicast fetch support is determined by a value of the provisioning control parameter, and a parameter of the service control file for each service. For example, the level of unicast fetch support for each service may be determined by taking a lesser value between enableUnicastFetchForDASH and serviceEnableUnicastFetch, according to the following formula (1) below. It is noted that enableUnicastFetchForDASH may be set in the provisioning file and may be applied to all services, and that serviceEnableUnicastFetch may be set per service in the service control file.

supportLevel=min(enableUnicastFetchForDASH,serviceEnableUnicastFetch) (1)

The service control file may be delivered as a body part of a service announcement multipart/related mime file that carries service announcement fragments. The UE may recognize the service control file based on the mime type. The service control file may be referenced in an envelope. The content-location of the service control file is listed both in the envelope and at the start of the body part containing the file. The content-location of the service control file may be generated by an entity generating a service announcement file. The validity time of the service control file may be later than the last validity time of any service listed in the service control file. The content-type of the body part providing the file may be set to “application/mbms_service_control+xml”.

Table 1 illustrates an example of various unicast fetch support levels for service IDs. In the example of Table 1, for the service IDs www.xyz.com/Srv0, www.xyz.com/Srv1, and www.xyz.com/Srv2, the provisioning control parameter enableUnicastForDASH is set to 1 for device 1. Thus, for serviceEnableUnicastFetch of 0, 1, and 2, the minimum between serviceEnableUnicastFetch and enableUnicastForDASH is 0, 1, and 2, respectively. For the service IDs www.xyz.com/Srv0, www.xyz.com/Srv1, and www.xyz.com/Srv2, the provisioning control parameter enableUnicastForDASH is set to 2 for device 2. Thus, for serviceEnableUnicastFetch of 0, 1, and 2, the minimum between serviceEnableUnicastFetch and enableUnicastForDASH is 0, 1, and 2, respectively.

TABLE 1
An example of various unicast fetch support levels for service IDs.

| | | serviceEnable- | Unicast |
|---|---|---|---|
| | | UnicastFetch | Fetch (UF) |
| | enableUnicast- | for service in | Support Level |
| ServiceID | FetchForDASH | received file | for Service |
| www.xyz.com/Srv0 | Set to 1 on | 0 or Service | 0 - UF |
| | Device 1 | not Listed | disabled |
| www.xyz.com/Srv1 | | 1 | 1 - Enabled |
| | | | at Start |
| www.xyz.com/Srv2 | | 2 | 1 - Enabled |
| | | | at Start |
| www.xyz.com/Srv0 | Set to 2 on | 0 or Service | 0 - UF |
| | Device 2 | not Listed | disabled |
| www.xyz.com/Srv1 | | 1 | 1 - Enabled |
| | | | at Start |
| www.xyz.com/Srv2 | | 2 | 2 - Start + |
| | | | Incomplete |
| | | | segments |

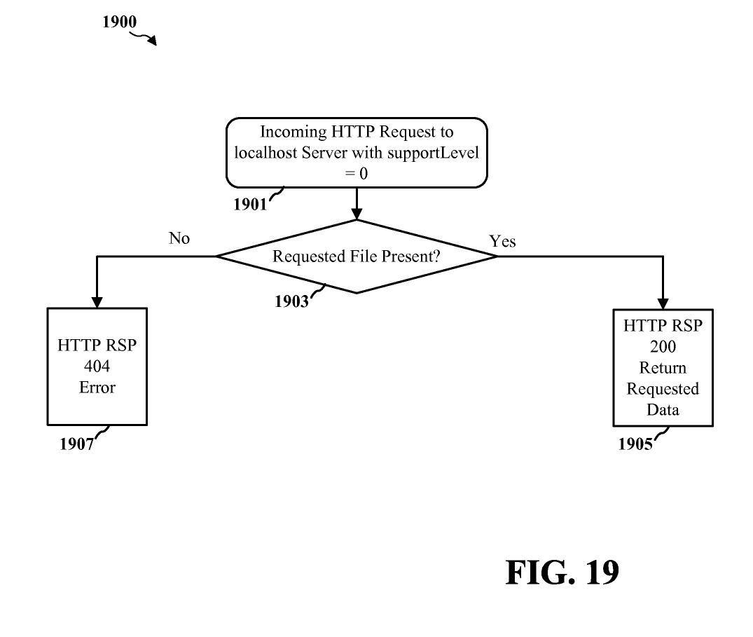

FIG. 19 is a flow chart 1900 illustrating a case where the unicast fetch support level is determined to be 0 according to the fourth approach. At 1901, the middleware receives an HTTP request directed to the local host server of the middleware, the middleware having the unicast fetch support level of 0. At 1903, the middleware determines whether the requested file is present. If the requested file is present, at 1905, the middleware returns the requested data with an HTTP response code 200. If the requested file is not present, at 1907, the middleware returns an HTTP response code 404 indicating an error.

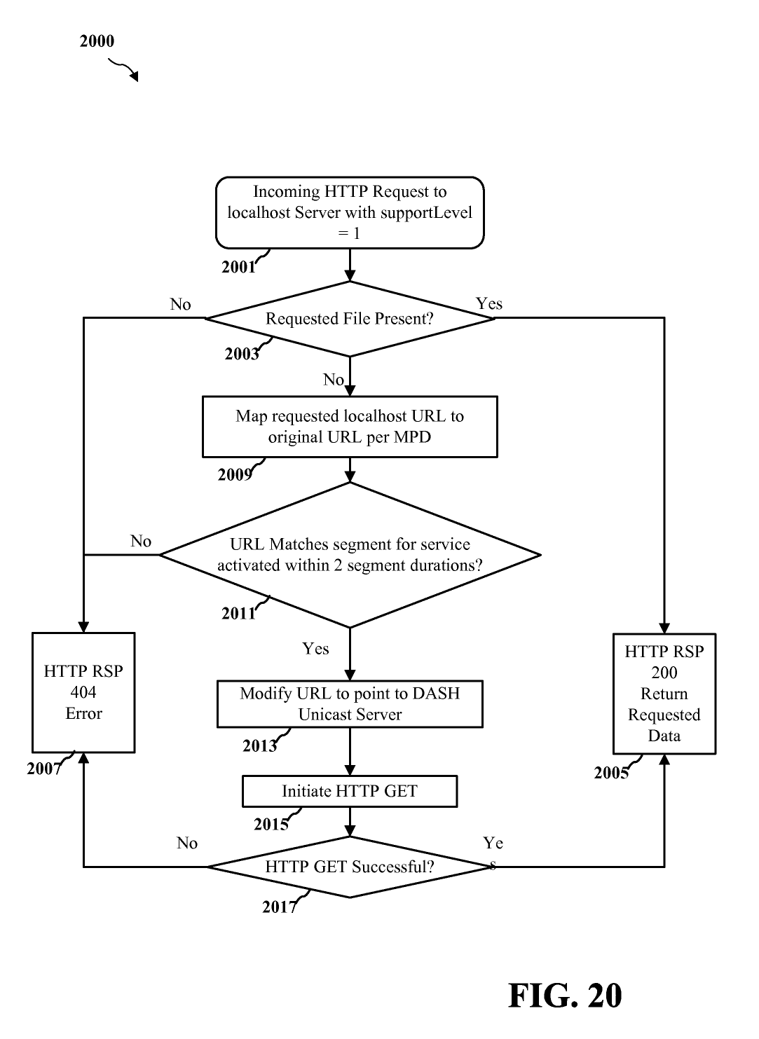

FIG. 20 is a flow chart 2000 illustrating a case where the unicast fetch support level is determined to be 1 according to the fourth approach. At 2001, the middleware receives an HTTP request directed to the local host server of the middleware, the middleware having the unicast support level of 1. At 2003, the middleware determines whether the requested file is present. If the requested file is present, at 2005, the middleware returns the requested data with an HTTP response code 200. If the requested file is not present, at 2007, the middleware returns an HTTP response code 404 indicating an error, and at 2009, the middleware maps an MPD URL including localhost information for the requested file to an original URL. At 2011, the middleware determines whether the URL matches a segment for service activated within two segment durations. If the URL does not match a segment for a service activated within two segment durations (e.g., the segment duration of segment n−2 and segment n−1), the middleware returns an HTTP response code 404 indicating an error. If the URL matches a segment for a service activated within two segment durations, at 2013, the middleware modifies the URL to point to the unicast server, and at 2015 initiates an HTTP GET message to fetch the segment from a unicast server. Thus, the incoming HTTP request for the file is replicated into the HTTP request to the unicast server for two segment durations after the service start. At 2017, the middleware determines whether the fetching of the segment from the unicast server is successful. If the fetching is successful, at 2005, the middleware returns the requested data with an HTTP response code 200. If the fetching is not successful, at 2007, the middleware returns an HTTP response code 404 indicating an error.

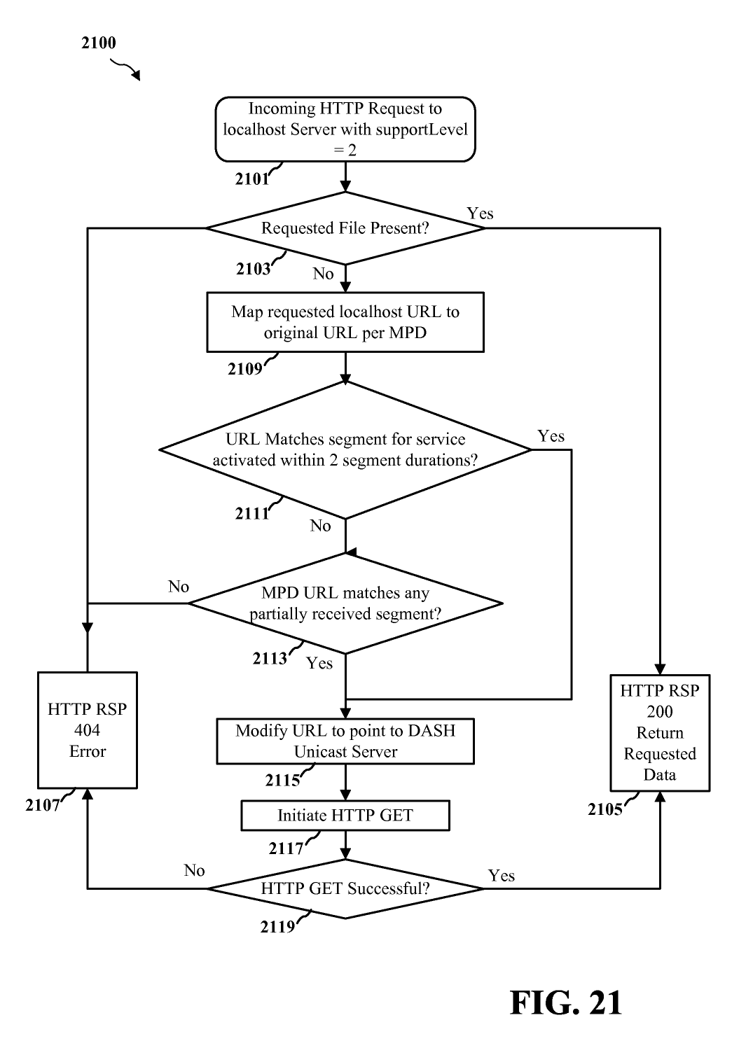

FIG. 21 is a flow chart 2100 illustrating a case where the unicast fetch support level is determined to be 2 according to the fourth approach. At 2101, the middleware receives an HTTP request directed to the local host server of the middleware, the middleware having the unicast support level of 1. At 2103, the middleware determines whether the requested file is present. If the requested file is present, at 2105, the middleware returns the requested data with an HTTP response code 200. If the requested file is not present, at 2107, the middleware returns an HTTP response code 404 indicating an error, and at 2109, the middleware maps an MPD URL including localhost information for the requested file to an original URL. At 2111, the middleware determines whether the URL matches a segment for service activated within two segment durations. If the URL does not match a segment for service activated within two segment durations (e.g., the segment duration of segment n−2 and segment n−1), at 2113, the middleware determines whether the MPD URL matches any of partially received segments. If the MPD URL does not match any of the partially received segments, at 2107, the middleware returns an HTTP response code 404 indicating an error. If the MPD URL matches any of the partially received segments, at 2115, the middleware modifies the MPD URL to point to the unicast server. Further, if the URL at 2111 matches a segment for service activated within two segment durations, at 2115, the middleware modifies the URL to point to the unicast server. At 2117, the middleware initiates an HTTP GET message to fetch the segment from the unicast server. Thus, the incoming HTTP request for the file is replicated into the HTTP request to the unicast server for two segment durations after the service start. Further, an HTTP request for any of partially received segments is also replicated into an HTTP request to the unicast server.

At 2119, the middleware determines whether the fetching of the segment from the unicast server is successful. If the fetching is successful, at 2105, the middleware returns the requested data with an HTTP response code 200. If the fetching is not successful, at 2107, the middleware returns an HTTP response code 404 indicating an error.

According to a fifth approach, a URL in the MPD is modified to allow revertability. With regard to a local HTTP server, the local HTTP server is configured to serve an HTTP request to retrieve missing segments from a unicast DASH server. For example, if enableUnicastFetchForDASH is set to 1 for the UE, for 2 segment durations, the local HTTP server redirects HTTP requests for missing segments from the DASH client to the unicast server (e.g., an external unicast DASH server). As another example, if enableUnicastFetchForDASH is set to 2 for the UE, the local HTTP server redirects HTTP requests for missing segments from the DASH client to the unicast server (e.g., an external unicast DASH server) when indicators (e.g., URIs) for the missing segments have been detected in a file delivery table (FDT).

A URL for a segment is modified to point to a local host when a local MPD is created to be sent to the DASH client. The middleware is configured to revert a modified URL back to the original URL. The middleware may save an external URL prefix before modifying the URL to point to a local host. When the middleware receives a request to fetch from the unicast server, the middleware may change back to the saved external URL prefix upon detecting a modified base URL. It is noted that the unicast fetch is not performed if the UE is beyond eMBMS coverage.

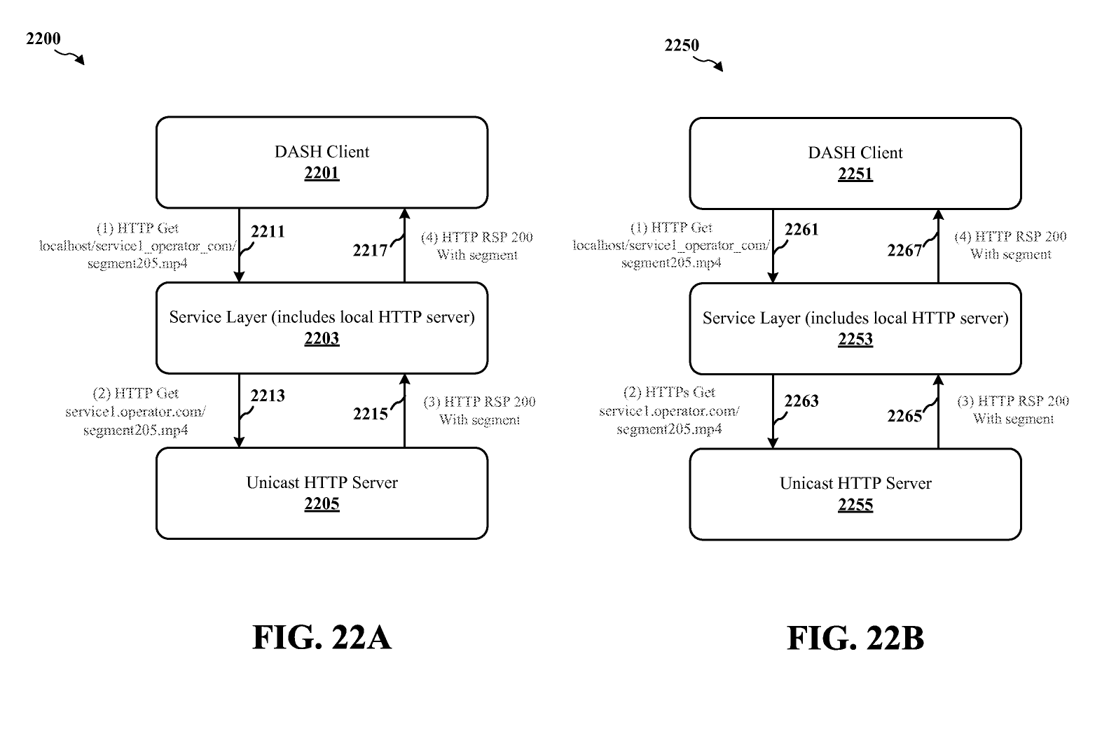

FIG. 22A is an example diagram 2200 illustrating interactions between a DASH client 2201, a service layer 2203, and a unicast HTTP server 2205 according to the fifth approach. The DASH client 2201 sends an HTTP request (e.g. HTTP Get) at 2211 to retrieve a missing segment segment205.mp4 with a modified URL to the service layer 2203 including a local server, if a missing segment exists. The service layer 2203 including the local server subsequently reverts the modified URL back to the original URL, and sends an HTTP request at 2213 to the unicast HTTP server 2205 to retrieve a missing segment segment205.mp4 with the original URL. The unicast HTTP server 2205 sends a response with the missing segment at 2215 to the service layer 2203, and then the service layer 2203 sends the response with the missing segment at 2217 to the DASH client 2201.

When HTTP is used, the middleware modifies an original URL by replacing the URL prefix with information on a local host and a port number (e.g., localhost:port) in the MPD sent to the DASH client and uses the original URL prefix as a part of the directory. In an example, a representation template may indicate that the original URL for a segment is: http://www.service.com/svc1/representation1/seg_video_$index$/. In the MPD sent to the DASH client, the original URL is modified to add “localhost:port” such that the modified URL becomes: http://localhost:9000/www.service.com/svc1/representation1/seg_video_$index$/. The process of modifying from the original URL to the modified URL may be reversed by removing the localhost prefix from the modified URL to regenerate the original URL. In the example, “localhost:9000” is removed as follows: http://www.service.com/svc1/representation1/seg_video_$index$/. Further, a one-way mapping of URLs to file names may be performed to provide access to the local storage. For example, if dots are not supported for a file name in the local storage, every dot may be changed to an underscore for saving files in the local storage and for retrieving files requested by URL.

In another example, an HTTPs access scheme with the original URL may be used to retrieve the missing segment from the unicast server. FIG. 22B is another example diagram 2250 illustrating interactions between a DASH client 2251, a service layer 2253, and a unicast HTTP server 2255 according to the fifth approach. The DASH client 2251 sends an HTTP request at 2261 to retrieve a missing segment segment205.mp4 with a modified URL to the service layer 2253 including a local server if the missing segment exists. The service layer 2253 including the local server subsequently reverts the modified URL back to the original URL, and sends an HTTPs request at 2263 to retrieve a missing segment segment205.mp4 with the original URL via the HTTPs access scheme to the unicast HTTP server 2255. The unicast HTTP server 2255 sends a response with the missing segment at 2265 to the service layer 2253, and the service layer 2253 sends the response with the missing segment at 2267 to the DASH client 2251.

The local server is an HTTP server. The modified local MPD uses HTTP. HTTPs is supported by maintaining knowledge of whether HTTPs was used in the original MPD. When HTTPs is used, the middleware modifies an original URL by replacing the URL scheme with http, and the URL prefix with localhost:port in the MPD passed to the DASH client and uses the original URL prefix. For example, a representation template may indicate that an URL for a segment is: https://www.service.com/svc1/representation1/seg_video_$index$/. In the MPD sent to the DASH client, the above URL is modified to replace https with http and to add localhost:9000 as follows: http://localhost:9000/www.service.com/svc1/representation1/seg_video_$index$/. This modifying process is reversible by changing the access scheme to HTTPs and removing the localhost prefix. In the example, “localhost:9000” is removed and http is changed to an https scheme as follows: https://localhost:9000/www.service.com/svc1/representation1/seg_video_$index$/.

According to a sixth approach, the middleware may utilize a file repair scheme to recover segments. Segments are made available through a file repair server. The file repair server may be a unicast server configured to communicate with the UE over unicast. For example, segment n−1 may be partially recovered via over the air transmission, and may not be completely received. A file repair process may allow faster recovery of segment n−1. In order to achieve the faster recovery, it may be beneficial to remove limits on download speeds and times of file repair information. In one implementation, the file repair is triggered when a file is determined to have an error. In another implementation, the file repair may be performed proactively before an error in the file is found. An indicator such as a flag (e.g. B flag) may be used to indicate that no more packets for a segment will be sent to the middleware, and thus an incomplete set of packets for the segment is received at the middleware. The middleware may implicitly assume that no more packets are sent for a segment if packets for a next transmission object identifier (TOI) (e.g., for a next segment) are received.

The middleware may detect a gap in symbol indices to determine whether a segment is unlikely to be recovered, as discussed in more detail infra. A segment may be encoded using No_Code_FEC, Raptor, or RaptorQ. The segment is normally encoded in one block. Each segment includes multiple symbols. The symbols are sent in ascending number of encoding segment IDs. First k symbols in each segment may be source symbols. Next n symbols may be repair symbols. The repair symbols may be associated with forward error correction (FEC) symbol identifiers. If the middleware detects repair symbols, then more symbols may be received to repair a segment with an error. By monitoring the start number and gaps in the received symbols, the middleware can determine early whether the segment is likely to fail. If the middleware determines that the segment is likely to fail, the middleware may trigger an early unicast fetch of the segment from the file repair server and/or perform a file repair. In an embodiment, the middleware may determine the FEC overhead used for segments and use the FEC overhead information to make early decisions on using file repair schemes to supplement the symbols received over broadcast with symbols received over unicast.

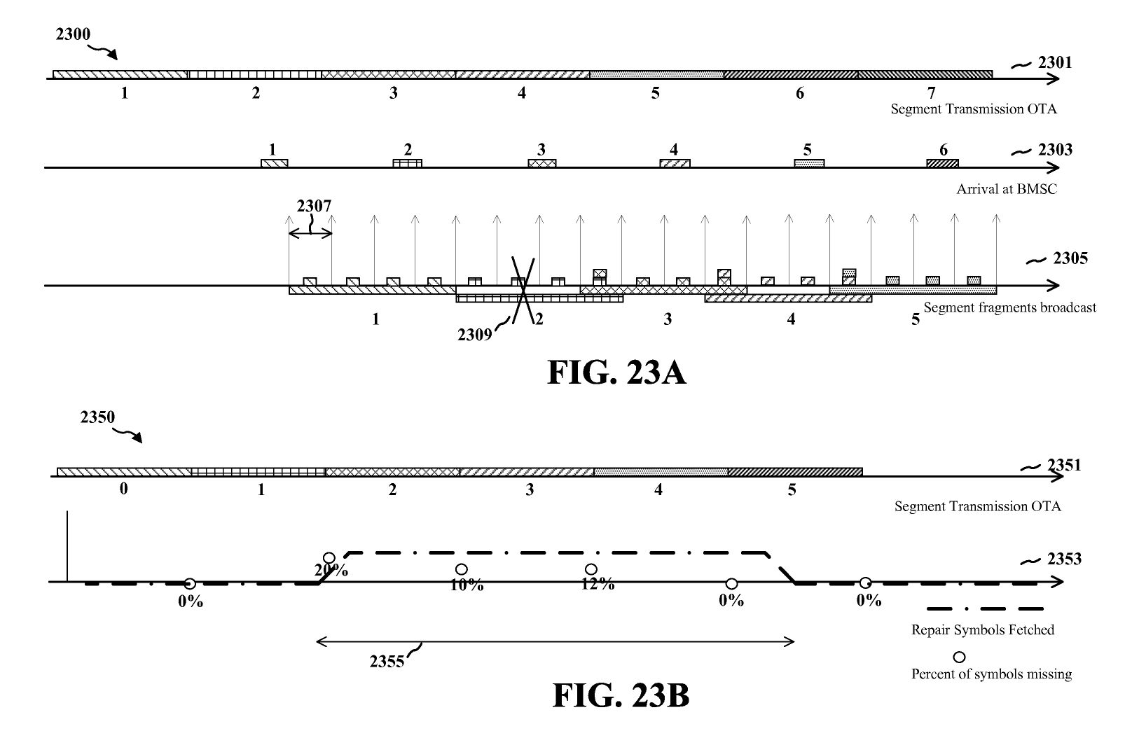

FIG. 23A is an example time diagram 2300 of error detection to repair a file according to the sixth approach. A segment transmission diagram 2301 illustrates that segments 1-7 are transmitted over the air. A BMSC arrival time diagram 2303 illustrates that encoded segments 1-6 arrive at the BMSC. A broadcast time diagram 2305 illustrates that fragments are broadcasted for each burst for the encoded segments 1-5. (The burst of the encoded segment 6 is not shown). Each of the fragments is broadcasted every MCH scheduling period (MSP), such as an MSP duration 2307. A first burst for segment 1 may include symbols 1-100, a second burst for segment 2 may include symbols 101-200, and a third burst for segment 3 may include symbols 201-300, and so on. In the example FIG. 23A, the second burst 2309 is missing, and thus symbols 101-200 are missing. At symbol 201, the middleware detects that the second burst is missing, and thus may determine to trigger an early unicast fetch for segment 2 from a file repair server and/or to trigger a file repair. For example, the middleware may determine that the second burst for segment 2 is missing if the middleware detects that segment 3 is being received when segment 2 is expected to be received. The middleware may consider a level of FEC protection that is an optional parameter in the FDT in determining whether to trigger the file repair. For example, if (symbols lost/total symbols)>Repair Redundancy Percentage, the file repair may be triggered.

If the file repair is available, the UE may monitor symbol error rates and supplement broadcast reception by requesting additional repair symbols from repair server. For example, when a FLUTE layer of the UE detects errors in symbols of the segments, the FLUTE layer of the UE signals to the middleware of the UE to proactively fetch additional symbols from a unicast server and receive the additional symbols over unicast to reduce the error rate. A hysteresis period may be added during which additional symbols are fetched from a file repair server for multiple incoming segments after a segment error is detected. FIG. 23B is an example time diagram 2350 illustrating repair symbols being fetched proactively according to the sixth approach. A segment transmission diagram 2351 illustrates that segments 0-5 are transmitted over the air. When an error is expected, the middleware fetches repair symbols proactively. A repair symbol diagram 2353 illustrates that repair symbols are proactively fetched during a hysteresis period 2355 after 20% error occurs, until the error becomes 0%.

A seventh approach is related to a bandwidth control of a unicast fetch feature. In the seventh approach, several algorithms may be implemented to control bandwidth usage of a unicast fetch. According to a first algorithm, the middleware may control the bandwidth usage using a token bucket approach with a token of a certain size added to the token bucket periodically over time. Tokens are added to the bucket until the bucket size limit is reached (e.g., the bucket is full of tokens). A unicast fetch of a segment consumes one token from the bucket. Thus, every time a unicast fetch is performed (e.g., for a missed segment), one token is subtracted from the bucket. When the bucket does not have any token (e.g., the bucket is empty), the unicast fetch may not be performed. In one example, the bucket may have a size that can hold up to M tokens, and a token may be added to the bucket for every SegmentDuration/X, where X may be on the order of 2, until the bucket is full of tokens.

According to a second algorithm, the middleware may control a bandwidth usage directly by monitoring a byte level in a bucket. A certain number of bytes are added to the bucket periodically over time. When a unicast fetch of a segment is performed, a number of bytes corresponding to the fetched segment is subtracted from the bucket. Thus, the second algorithm is different from the first algorithm in that the number of bytes is reduced from the bucket level, rather than the number of tokens. For example, according to the second approach, a segment having a larger byte size will cause subtracting a larger byte size from the bucket level, whereas a token according to the first approach is consumed for each segment regardless of the byte size of the segment. The unicast fetch is enabled if the bucket level is positive. It is noted that a byte size of a segment to be fetched is not always known prior to fetching. The unicast fetch is not performed if the bucket level is zero or negative (e.g., the bucket is empty).

According to a third algorithm, the middleware utilizes a hold-and-enable approach of the unicast fetch feature based on an error gap. The detection gap algorithm may be defined. According to the detection gap algorithm, the middleware detects a reception gap if an elapsed time since the last received segment for the service is greater than a detection timer T_{detection}. The middleware places the unicast feature on hold (e.g., disabled) when a reception gap is detected. The middleware re-enables the unicast fetch feature upon a next successful reception of a segment. The middleware may also issue an indication of start of a service (e.g., SVC_STARTED) when the unicast fetch feature is re-enabled. It is noted that, if enableUnicastFetchForDASH is set to 2, T_{detection} may be increased by the value of a provisioning parameter additionalReceptionGapWithUnicastFetch at the activation of the DASH client and during reception.

At least two configurable parameters may be used to set the detection timer T_{detection}. One parameter is a reception gap (e.g., Reception_Gap) that indicates an acceptable gap in reception time of one or more segments. Another parameter is a delay jitter (e.g., Delay_Jitter) that indicates a maximum additional delay introduced by traffic shaping at the BMSC. Thus, the middleware may rely on the equation (2) to determine the detection timer T_{detection} using the two parameters.

T_{detection}=max(SegmentDuration,Reception_Gap)+Delay_Jitter. (2)

At the activation of the DASH client, the middleware may set an initiation detection timer T_{detection}_{_{—}}ᵢₙᵢₜ upon receiving the service start request, according to the equation (3). The initiation detection timer T_{detection}_{_{—}}ᵢₙᵢₜ may be longer than T_{detection.}

T_{detection}_{_{—}}ᵢₙᵢₜ=SegmentDuration+max(SegmentDuration,Reception_Gap)+Delay_Jitter. (3)

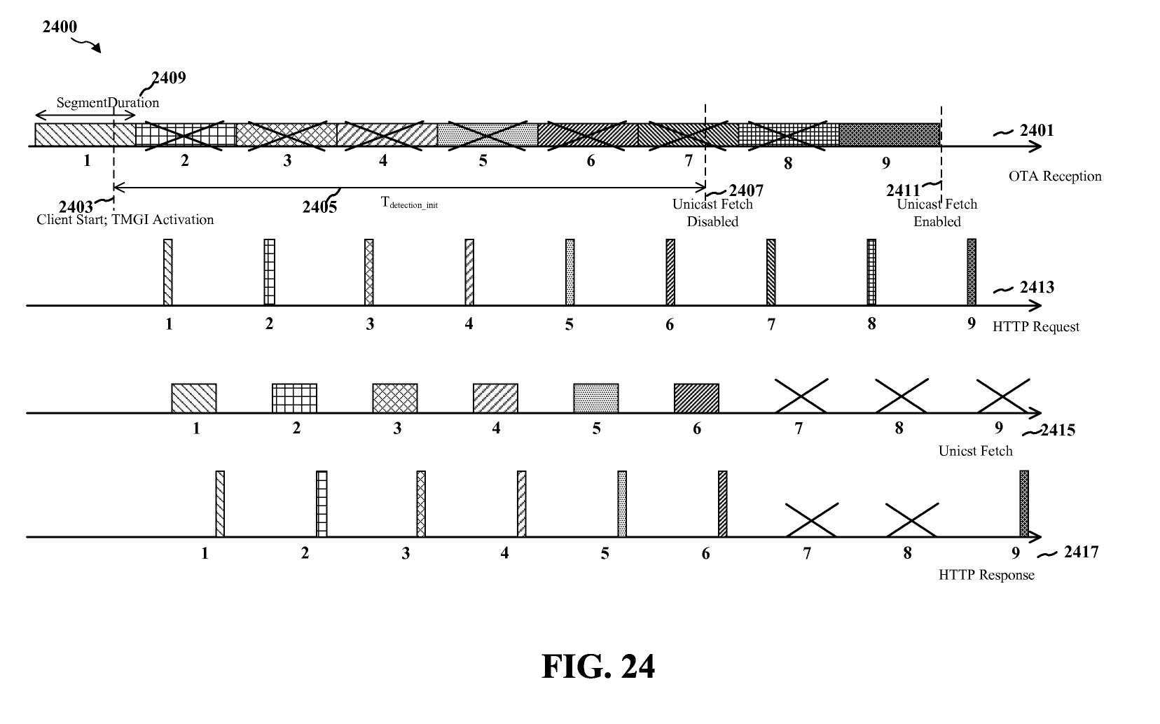

FIG. 24 is an example set of time diagrams 2400 illustrating an algorithm of a hold-and-enable approach of a unicast fetch feature based on gap detection, according to the seventh approach. A segment transmission diagram 2401 illustrates that segments 1-9 are received over the air. The DASH client is activated at a timeline 2403. When the segments are not successfully received, the middleware maintains the unicast fetch feature enabled until the initiation detection timer T_{detection}_{_{—}}ᵢₙᵢₜ for the DASH client activation 2405 elapses. If the segments are not successfully received over unicast for the initiation detection timer T_{detection}_{_{—}}ᵢₙᵢₜ 2405, the middleware disables (e.g., places on hold) the unicast fetch feature at a timeline 2407. When the middleware successfully receives segment 9 over the air, the middleware re-enables the unicast fetch feature at a time line 2411 after receiving segment 9. Segment 9 may be received over broadcast. In one example, at the activation of the DASH client, T_{detection}_{_{—}}ᵢₙᵢₜ may be on the order of receptionGap+additionalReceptionGapWithUnicastFetch. T_{detection}_{_{—}}ᵢₙᵢₜ may be approximately 6 seconds. The segment duration 2409 for each segment may be approximately 1 second. An HTTP request time diagram 2413 illustrates that the middleware sends HTTP requests to fetch segments 1-9. A unicast fetch time diagram 2415 illustrates that unicast fetches are performed for segments 1-6, but are not performed for segments 7-9 because the unicast fetch is disabled at a timeline 2407. An HTTP response time diagram 2417 illustrates that the HTTP responses for segments 1-6 are successful, and the HTTP responses for segments 7 and 8 are not successful. The HTTP response for segment 9 is successful despite the disabled unicast fetch feature because segment 9 is received over broadcast, not over unicast.

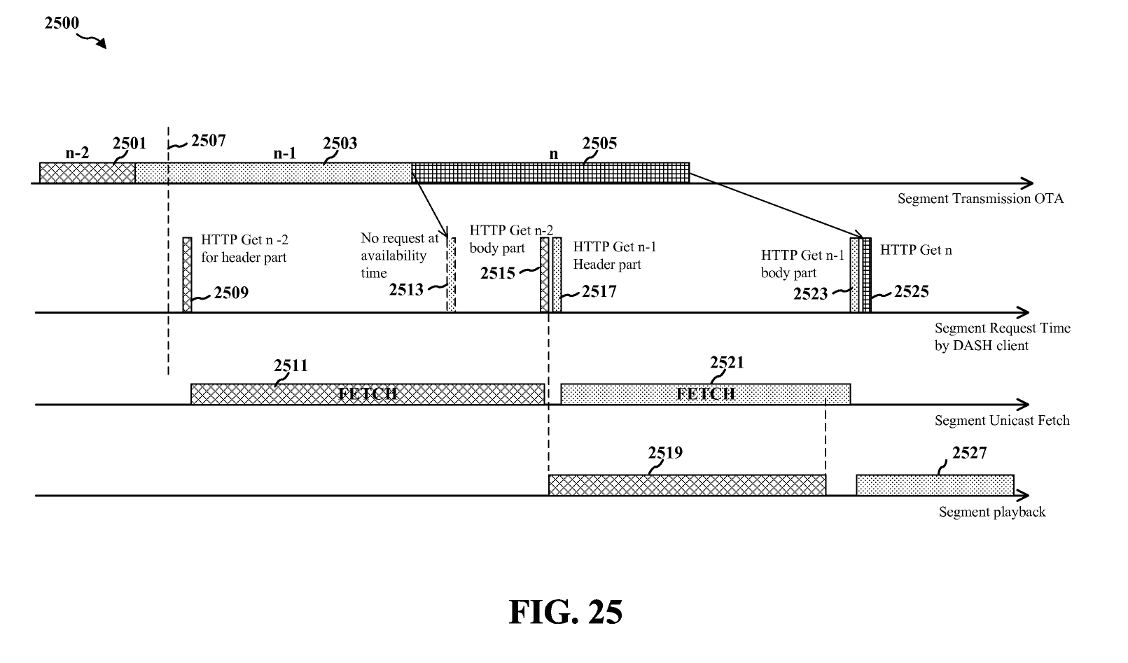

An eighth approach provides various ways to manage an excessive unicast delay. Generally, on the DASH encoder side, a subsequent segment fetch may be delayed until a response to an already issued HTTP request is received. The client sets a timer for a next request after receiving a response to the first HTTP GET request. The client will delay the next HTTP GET request until all of the previous segments are received, resulting in a playback delay of segments. In particular, a slow unicast channel may delay the playback of segments, as illustrated in FIG. 25.

FIG. 25 is a time diagram 2500 illustrating an excessive unicast delay. According to FIG. 25, eMBMS service segments such as segment n−2 2501, segment n−1 2503, and segment n 2505 are sequentially transmitted over the air. In the example illustrated in FIG. 25, a DASH client is activated at an activation time 2507 during transmission of segment n−1 2503. After the DASH client is activated at the activation time 2507, the DASH client transmits a request 2509 to retrieve a header part of segment n−2. Upon receiving the request 2509 to retrieve the header part of the segment n−2, the middleware fetches segment n−2 2511. It is noted that no request for any part of segment n−1 is fetched at an availability time 2513 for segment n−1 because the fetching of the segment n−2 2511 is still being performed at the availability time 2513 for segment n−1. After the fetching of the segment n−2 2511 is completed, a request 2515 to retrieve a body part of segment n−2 and a request 2517 to retrieve a header part of segment n−1 are sequentially transmitted. After the request 2515 to retrieve a body part of segment n−2 is sent, playback 2519 of segment n−2 is performed. Because the fetching of the segment n−2 2511 is approximately 1.5 times the segment duration, the fetching of the segment n−2 2511 delays playback start time and a request for segment n−1. After the request 2517 to retrieve a header part of segment n−1 is sent, fetching of segment n−1 2521 is performed. After the fetching of segment n−1 2521 is completed, a request 2523 to retrieve a body part of segment n−1 and a request 2525 to retrieve segment n are sequentially transmitted. After the request 2523 to retrieve a body part of segment n−1 is sent, playback 2527 of segment n−1 is performed. Thus, the long duration for fetching segment n−2 2511 delays the time for the request 2525 to retrieve segment n and the time for the playback 2527 of segment n−1.

At least two enhancements may be made to address the issue associated with excessive delays. According to a first enhancement, if a response to a relayed unicast request is not completely received within a segment duration, the middleware aborts the unicast fetch and responds by sending a 404 error to any local HTTP request. According to a second enhancement, the unicast fetch feature for a service is disabled if fetching (e.g., via an HTTP Get) of a segment takes more than a segment duration to retrieve the segment over unicast. It is noted that the unicast fetch at the start of the activation of the DASH client is within 2 segment durations of the start time of the service. The unicast fetch that is disabled for earlier segments may be enabled again for later segments. To implement the above enhancements, the logical streaming module may inform the logical unicast fetch module of the segment duration per service. The middleware may manage a timer per outstanding unicast HTTP GET request. The middleware may disable unicast fetch during the rest of a start period if the timer indicates that any outstanding unicast fetch is timed out for the service during the start period.

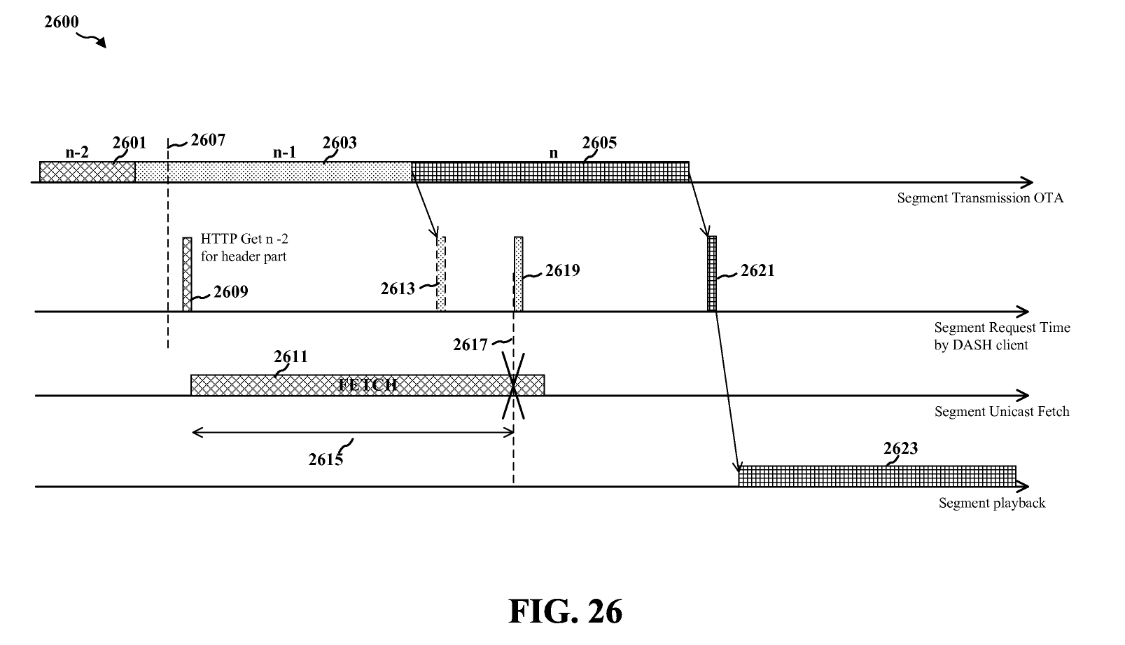

FIG. 26 is an example time diagram 2600 illustrating aborting of fetching in case of an excessive unicast delay, according to the eighth approach. According to FIG. 26, eMBMS service segments such as segment n−2 2601, segment n−1 2603, and segment n 2605 are sequentially transmitted over the air. In the example illustrated in FIG. 26, a DASH client is activated at an activation time 2607 during transmission of segment n−1 2603. After the DASH client is activated at the activation time 2607, the DASH client transmits a request 2609 to retrieve a header part of segment n−2. Upon receiving the request 2609 to retrieve the header part of the segment n−2, the segment n−2 2611 is fetched. It is noted that no request for any part of segment n−1 is fetched at an available time 2613 for segment n−1 because the fetching of the segment n−2 2611 is still being performed at the available time 2613 for segment n−1. When the middleware determines that the fetching of the segment n−2 2611 takes longer than the segment duration 2615, the middleware aborts the fetching of the segment n−2 2611 at the end time 2617 of the segment duration 2615. Because the middleware aborts the fetching of segment n−2 2611, the middleware fails to receive all of segment n−2 when a timer for fetching expires, and thus issues an error response (e.g., a 404 response) and discards retrieved data of segment n−2. Further, upon detecting that the fetching of the segment n−2 2611 takes longer than the segment duration 2615, the middleware disables the unicast fetch feature. Thus, when the DASH client sends a request 2619 to retrieve segment n−1 over unicast, the middleware returns an error (e.g., 404 error) because the unicast fetch feature is disabled. Because the fetching of segment n−2 2611 is aborted and fetching of segment n−1 is not performed, a request 2621 to retrieve segment n over broadcast is transmitted without a delay caused by the fetching of segment n−2 2611. When the request 2621 to retrieve segment n is transmitted without any delays, the middleware re-enables the unicast fetch feature. Playback of segment n 2623 is performed without delays, as if the unicast fetch feature is disabled.

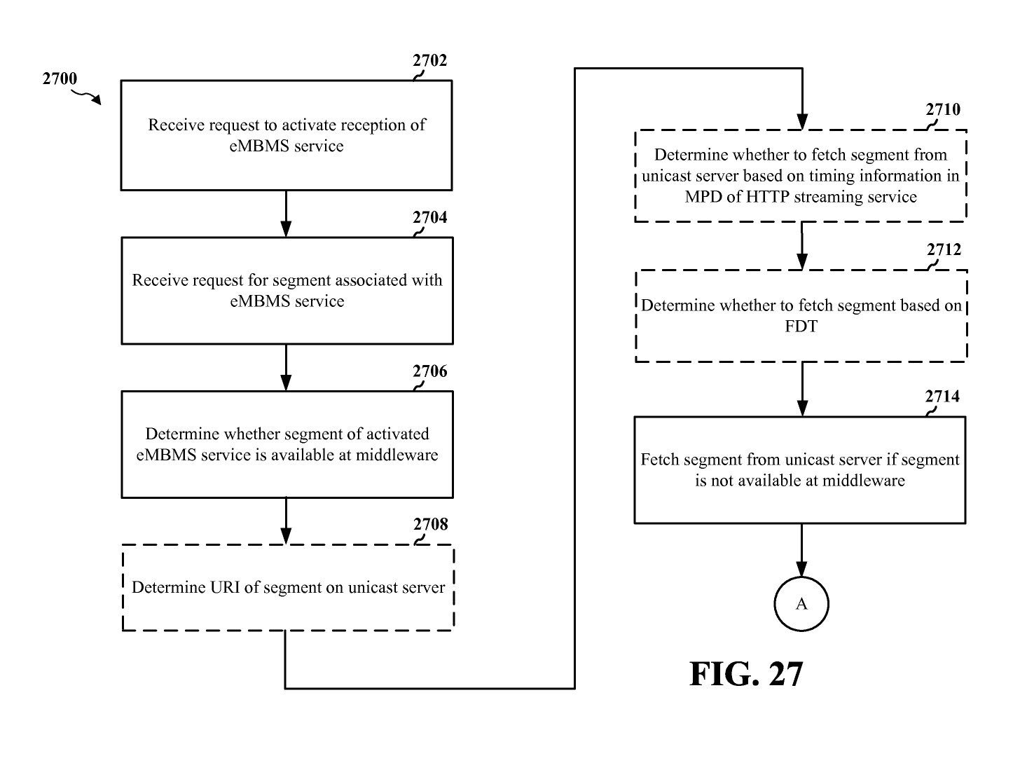

FIG. 27 is a flow chart 2700 of a method of wireless communication. The method may be performed by a middleware (e.g., eMBMS middleware) of the UE. At 2702, the middleware receives a request to activate reception of an eMBMS service. At 2704, the middleware receives a request for a segment associated with the eMBMS service. At 2706, the middleware determines whether the segment of the activated eMBMS service is available at the middleware. At step 2708, the middleware may determine a URI of the segment on the unicast server. At step 2710, the middleware may determine whether to fetch the segment from the unicast server based on timing information in an MPD of a HTTP streaming service. At 2712, the middleware may determine whether to fetch the segment based on an FDT. In an aspect, the FDT may include information about one or more segments to be delivered over broadcast. Finally, at 2714, the middleware fetches the segment from the unicast server if the segment is not available at the middleware. In an aspect, the fetching the segment may include fetching the entire segment or fetching a portion of the segment.

For example, referring back to FIG. 10, as discussed supra, upon activation of the DASH client in the UE 1001, if the middleware of the UE 1001 determines that the first few segments are not available at the middleware of the UE 1001, the middleware of the UE 1001 may fetch a first few segments over unicast, and then fetch the rest of the segments over broadcast. As discussed supra, the middleware may parse the MPD, and determine whether a next segment should be fetched over unicast based on various factors such as a template and current time. As discussed supra, if URIs for missing segments have been detected in an FDT, the local HTTP server of the middleware fetches for the missing segments.

In an aspect, the segment may be fetched from the unicast server based on the URI of the segment. For example, as discussed supra, referring back to FIG. 17, the eMBMS middleware 1705 determines a URI on the unicast server 1709, where the URI corresponds to the segment to be fetched. In an aspect, the segment may belong to one or more representations whose segments are broadcasted over eMBMS. In an aspect, the segment may include one or more initial segments being broadcast at or before a time of the activation of the reception of the eMBMS service. Referring back to FIG. 13, segments n−2 and segment n−1 are broadcasted at or before a time of the activation time 1307 of the DASH client to receive the segments.

In one aspect, the determining whether the segment of the activated eMBMS service is available at the middleware may be performed before receiving the request for the segment. For example, referring back to FIG. 12, according to option 1A, at 1233, the eMBMS middleware 1205 obtains segment n−2 and segment n−1 from the unicast server 1209 over unicast, before receiving a request for segment n−2 or segment n−1. In another aspect, the determining whether the segment of the activated eMBMS service is available at the middleware may be performed upon receiving the request for the segment. For example, referring back to FIG. 12, according to option 1B, at 1237, the eMBMS middleware 1205 obtains segment n−2 from the unicast server 1209 over unicast in response to the HTTP GET request.

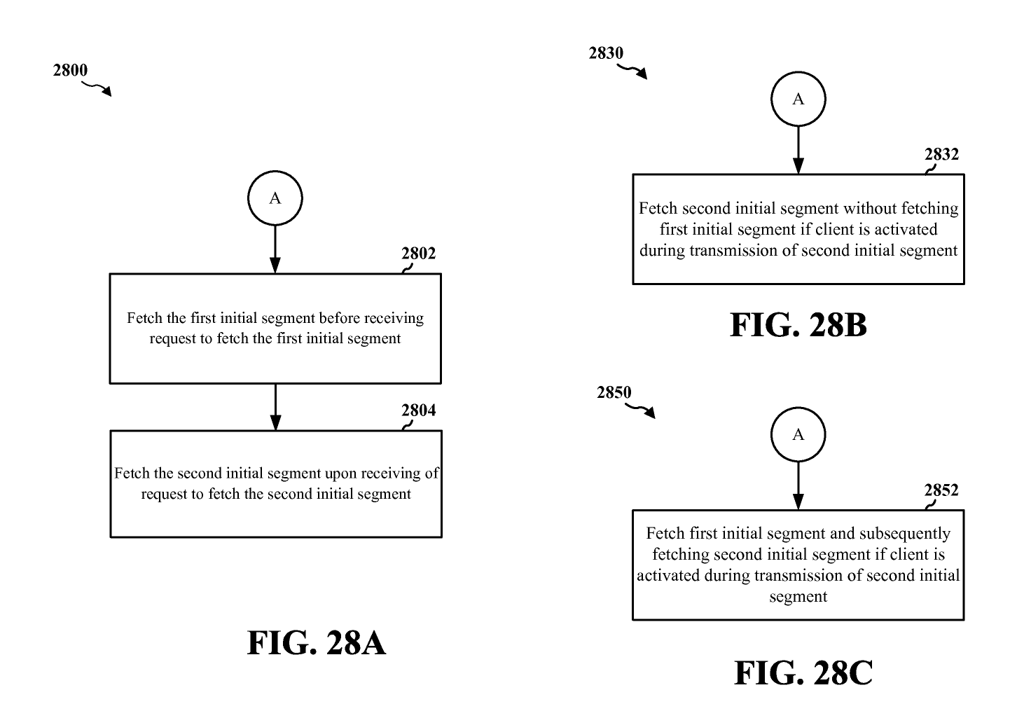

FIG. 28A is a flow chart 2800 of a method of wireless communication expanding from FIG. 27. The method may be performed by the middleware of the UE. The segment may include a first initial segment and a second initial segment subsequent to the first initial segment. At 2802, the middleware fetches the first initial segment before receiving a request to fetch the first initial segment. At 2804, the middleware fetches the second initial segment upon receiving a request to fetch the second initial segment. For example, as discussed supra, the middleware may utilize the proactive approach according to option 1A to fetch the first segment before receiving a fetch request for the first segment and may utilize the reactive approach according to option 1B to fetch the second segment upon receiving a fetch request for the second segment.

FIG. 28B is a flow chart 2830 of a method of wireless communication expanding from FIG. 27. The method may be performed by the middleware of the UE. The segment may include a first initial segment and a second initial segment subsequent to the first initial segment. At 2832, the middleware fetches the second initial segment without fetching the first initial segment if the client is activated during transmission of the second initial segment. For example, referring back to FIG. 15, according to option 2A, segment n−1 is fetched, but segment n−2 is not fetched.

FIG. 28C is a flow chart 2850 of a method of wireless communication expanding from FIG. 27. The method may be performed by the middleware of the UE. The segment may include a first initial segment and a second initial segment subsequent to the first initial segment. At 2832, the middleware fetches the first initial segment and subsequently fetches the second initial segment if the client is activated during transmission of the second initial segment. For example, referring back to FIG. 15, according to option 2B, both segment n−1 and segment n−2 may be fetched over unicast.

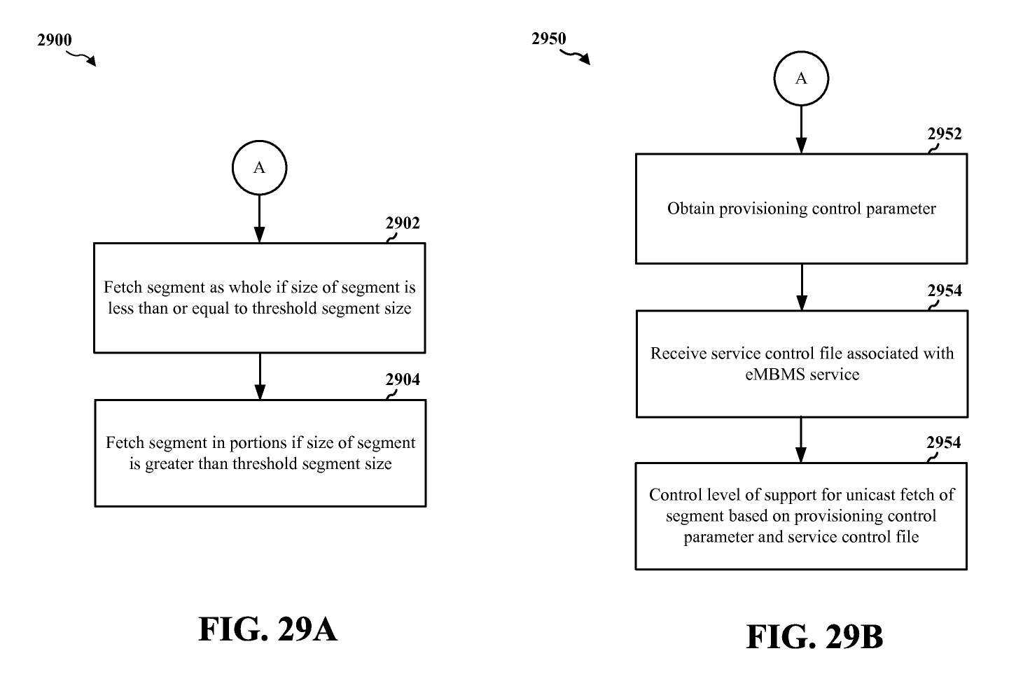

FIG. 29A is a flow chart 2900 of a method of wireless communication expanding from FIG. 27. The method may be performed by the middleware of the UE. At 2902, the middleware fetches the segment as a whole if a size of the segment is less than or equal to a threshold segment size. At 2904, the middleware fetches the segment in portions if the size of the segment is greater than the threshold segment size. As discussed supra, if the segment size is less than or equal to a threshold segment size, the middleware may fetch the whole segment, and otherwise, the middleware may fetch the segment in portions.

In one aspect, the fetching the segment as a whole may include receiving a request for an initial portion of the segment and requesting the unicast server to fetch for the segment as a whole if the size of the segment is less than or equal to the threshold segment size. For example, referring back to FIG. 17, when receiving an HTTP GET request for a header portion of segment n−2, the eMBMS middleware 1705 sends an HTTP Get request over unicast to the unicast server 1709 to fetch segment n−2 as a whole. In another aspect, the fetching the segment in portions may include receiving a request for an initial portion of the segment, requesting the unicast server to fetch the initial portion of the segment if the size of the segment is greater than the threshold segment size, receiving a request for a remaining portion of the segment, and requesting the unicast server to fetch the remaining portion of the segment. For example, referring back to FIG. 18, when receiving an HTTP GET request for a header portion of segment n−2, at 1835, the eMBMS middleware 1805 sends an HTTP Get request over unicast to the unicast server 1809 to fetch a header portion of segment n−2. Referring back to FIG. 18, when receiving an HTTP GET request for the rest of segment n−2, at 1845, the eMBMS middleware 1805 sends an HTTP Get request over unicast to the unicast server 1809 to fetch the rest of segment n−2.

FIG. 29B is a flow chart 2950 of a method of wireless communication expanding from FIG. 27. The method may be performed by the middleware of the UE. At 2952, the middleware obtains a provisioning control parameter. At 2954, the middleware receives a service control file associated with the eMBMS service. At 2956, the middleware controls a level of support for the unicast fetch of the segment based on the provisioning control parameter and the service control file. In one aspect, the level of support may be determined based on a lesser of the provisioning control parameter and a unicast fetch parameter of the service control file. As discussed supra, for example, the middleware may also consider the provisioning parameter to control the unicast fetch feature depending on a service, and a service control file may be used to control the unicast fetch feature depending on a device. As discussed supra, for example, the level of unicast fetch support for each service may be determined by taking a lesser value between enableUnicastFetchForDASH and serviceEnableUnicastFetch. In an aspect, the controlled level of support may include a level of support that enables the unicast fetch to be active for two segment durations after the activation of a service. In an aspect, the controlled level of support may include a level of support that maintains the unicast fetch to be active. As discussed supra, for example, when the provisioning parameter is set to 1, the unicast fetch feature is enabled at a beginning (e.g., for a period of 2 segment durations after the start of a service) of the service as long as initial unicast fetch parameter (e.g., unicastFetch) is enabled for the service in the service control file. As discussed supra, for example, when the provisioning parameter is set to 2, the unicast fetch feature is enabled at the beginning of the service, and may also be enabled at the end if an incomplete segment is received at the end due to an error in the channel.

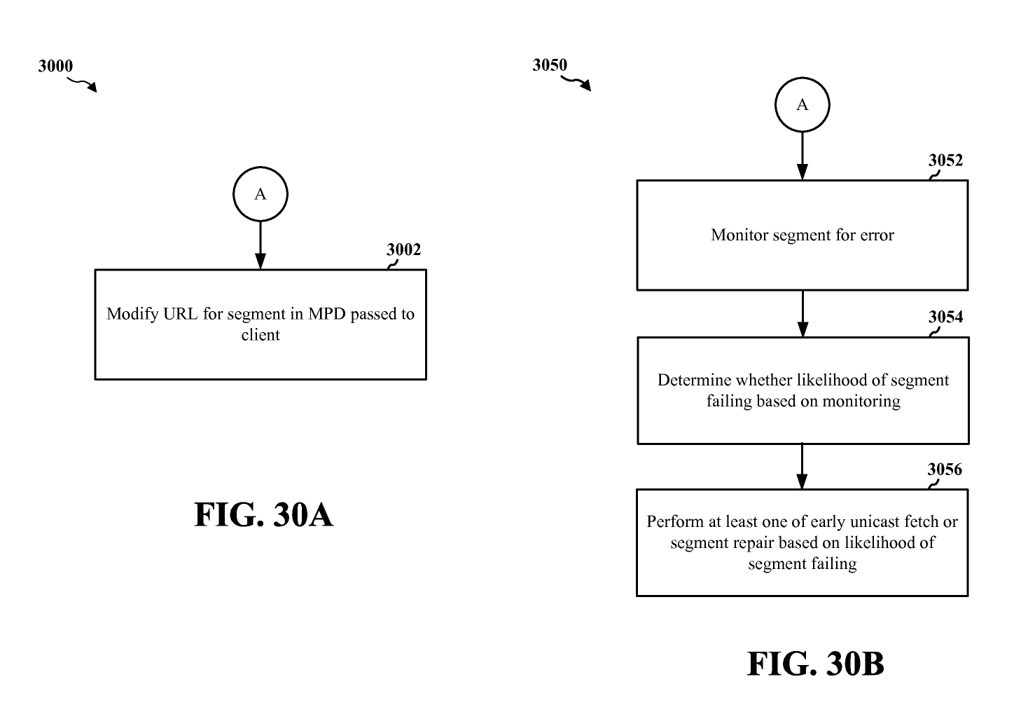

FIG. 30A is a flow chart 3000 of a method of wireless communication expanding from FIG. 27. The method may be performed by the middleware of the UE. At 3002, the middleware modifies a URL for the segment in an MPD passed to the client. In an aspect, the modified URL is capable of being reverted back to the URL. In an aspect, the modification of the URL in the MPD may include adding a local host name and a port number to the URL. In an aspect, the modification of the URL in the MPD may further include modifying a URL scheme. For example, as discussed supra, in the MPD sent to the DASH client, the original URL is modified to add “localhost:port,” and the process of modifying from the original URL to the modified URL may be reversed by removing the localhost prefix from the modified URL to regenerate the original URL. For example, as discussed supra, a modifying process of the URL may be reversible by changing the access scheme to HTTPs and removing the localhost prefix.

FIG. 30B is a flow chart 3050 of a method of wireless communication expanding from FIG. 27. The method may be performed by the middleware of the UE. At 3052, the middleware monitors the segment for an error. In an aspect, the monitoring the segment for the error may include monitoring one or more FEC symbol identifiers received for the segment to determine a missing portion of the segment. At 3054, the middleware determines whether a likelihood of the segment failing based on the monitoring. At 3056, the middleware performs at least one of an early unicast fetch or segment repair based on the likelihood of the segment failing. In an aspect, the performing may include fetching additional symbols from a file repair server. In an aspect, the error may occur when the segment has a missing portion. For example, as discussed supra, by monitoring the start number and gaps in the received symbols, the middleware can determine early whether the segment is likely to fail. As discussed supra, if the middleware determines that the segment is likely to fail, the middleware may trigger an early unicast fetch of the segment from the file repair server and/or perform a file repair

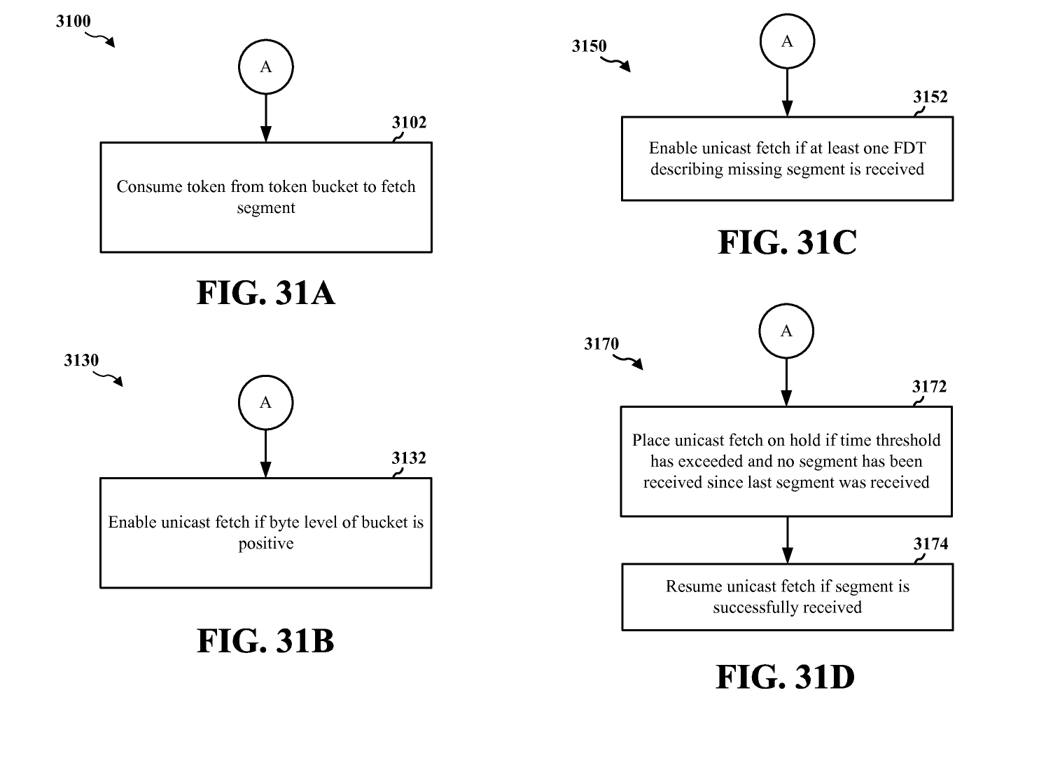

FIG. 31A is a flow chart 3100 of a method of wireless communication expanding from FIG. 27. The method may be performed by the middleware of the UE. At 3102, the middleware consumes a token from a token bucket to fetch the segment, where a number of tokens in the token bucket is increased over time and is decreased by one each time a segment is fetched. For example, as discussed supra, when a token bucket approach is used where a token of a certain size is added to the token bucket periodically over time, one token is subtracted from the bucket every time a unicast fetch is performed.

FIG. 31B is a flow chart 3130 of a method of wireless communication expanding from FIG. 27. The method may be performed by the middleware of the UE. At 3132, the middleware enables a unicast fetch if a byte level of a bucket is positive. A byte level in the bucket is increased with time and is decreased by an amount of the unicast fetch. For example, as discussed supra, when a unicast fetch of a segment is performed, a number of bytes corresponding to the fetched segment is subtracted from the bucket. As discussed supra, the unicast fetch is enabled if the bucket level is positive.

FIG. 31C is a flow chart 3150 of a method of wireless communication expanding from FIG. 27. The method may be performed by the middleware of the UE. At 3152, the middleware enables a unicast fetch if at least one FDT describing a segment that is missing or is likely to be missing is received. As discussed supra, if URIs for missing segments have been detected in an FDT, the local HTTP server of the middleware fetches for the missing segments.

FIG. 31D is a flow chart 3170 of a method of wireless communication expanding from FIG. 27. The method may be performed by the middleware of the UE. At 3172, the middleware places a unicast fetch on hold if a time threshold has exceeded and no segment has been received since a last segment was received (e.g., over broadcast). At 3174, the middleware resumes the unicast fetch if a segment is successfully received. For example, referring back to FIG. 24, if the segments are not successfully received over unicast for the initiation detection timer T_{detection}_{_{—}}ᵢₙᵢₜ 2405, the middleware disables (e.g., places on hold) the unicast fetch feature at a timeline 2407. Referring back to FIG. 24, when the middleware successfully receives segment 9 over the air, the middleware re-enables the unicast fetch feature at a time line 2411 after receiving segment 9.

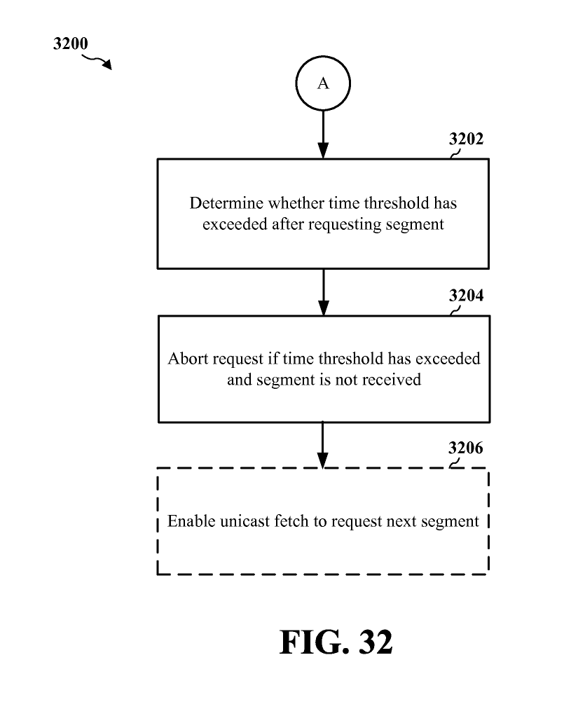

FIG. 32 is a flow chart 3200 of a method of wireless communication expanding from FIG. 27. The method may be performed by the middleware of the UE. At 3202, the middleware determines whether a time threshold has exceeded after requesting the segment. In an aspect, the time threshold may be based on a segment duration to be received over unicast via the unicast server. In an aspect, the time threshold may be one segment duration. At 3204, the middleware aborts the request if the time threshold has exceeded and the segment is not received. For example, referring back to FIG. 26, when the middleware determines that the fetching of the segment n−2 2611 takes longer than the segment duration 2615, the middleware aborts the fetching of the segment n−2 2611 at the end time 2617 of the segment duration 2615. At 3206, the middleware may enable a unicast fetch to request a next segment. As discussed supra, the unicast fetch that is disabled for earlier segments due to excessive delays may be enabled again for later segments.

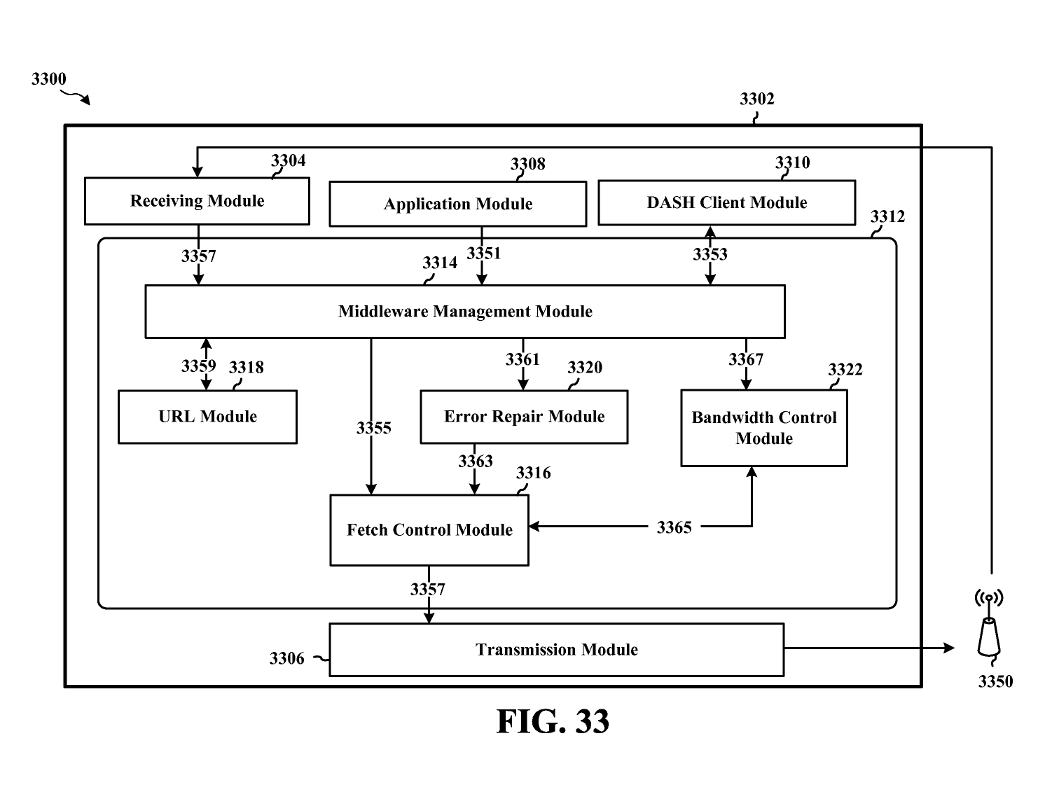

FIG. 33 is a conceptual data flow diagram 3300 illustrating the data flow between different modules/means/components in an exemplary apparatus 3302. The apparatus may be a UE. The apparatus includes a receiving module 3304, a transmission module 3306, an application module 3308, a DASH client module 3310, and an eMBMS middleware 3312. The eMBMS middleware 3312 may include a middleware management module 3324, a fetch control module 3316, a URL module 3318, an error repair module 3320, and a bandwidth control module 3322. The middleware management module 3314 receives a request to activate reception of an eMBMS service from the application module 3308 at 3351. The middleware management module 3314 receives a request for a segment associated with the eMBMS service from the DASH client module 3310 at 3353. The fetch control module 3316 determines whether the segment of the activated eMBMS service is available at the middleware through 3355, and fetches through 3357 the segment from a unicast server via the transmission module 3306 if the segment is not available at the middleware. In an aspect, the fetching the segment may include fetching the entire segment or fetching a portion of the segment. The fetch control module 3316 may determine a URI of the segment on the unicast server. In an aspect, the segment may be fetched from the unicast server based on the URI of the segment. The fetch control 3116 may determine whether to fetch the segment from the unicast server based on timing information in an MPD of a HTTP streaming service. The fetch control module 3316 may determine whether to fetch the segment based on an FDT. In an aspect, the FDT may include information about one or more segments to be delivered over broadcast. In an aspect, the segment may belong to one or more representations whose segments are broadcasted over eMBMS. In an aspect, the segment may include one or more initial segments being broadcast at or before a time of the activation of the reception of the eMBMS service.

In an aspect, the fetch control module 3316 may determine whether the segment of the activated eMBMS service is available at the middleware before receiving the request for the segment. In an aspect, the fetch control module 3316 may determine whether the segment of the activated eMBMS service is available at the middleware upon receiving the request for the segment. In an aspect where the segment includes a first initial segment and a second initial segment subsequent to the first initial segment, the fetch control module 3316 may fetch the first initial segment via the transmission module 3306 before receiving a request to fetch the first initial segment, and fetch the second initial segment via the transmission module 3306 upon receiving a request to fetch the second initial segment from the DASH client module 3310 through the middleware management module 3314.

In an aspect where the segment includes a first initial segment and a second initial segment subsequent to the first initial segment, the fetch control module 3316 may fetch the second initial segment via the transmission module 3306 without fetching the first initial segment if the client is activated via the DASH client module 3310 during transmission of the second initial segment. In an aspect where the segment includes a first initial segment and a second initial segment subsequent to the first initial segment, the fetch control module 3316 may fetch the first initial segment and subsequently fetch the second initial segment via the transmission module 3306 if the client is activated via the DASH client module 3310 during transmission of the second initial segment.

The fetch control module 3316 may fetch the segment as a whole via the transmission module 3306 if a size of the segment is less than or equal to a threshold segment size, and fetch the segment in portions via the transmission module 3306 if the size of the segment is greater than the threshold segment size. In an aspect, the fetch control module 3316 may fetch the segment as a whole by receiving a request for an initial portion of the segment from the DASH client module 3310, and requesting the unicast server, via the transmission module 3306, to fetch for the segment as a whole if the size of the segment is less than or equal to the threshold segment size. In an aspect, the fetch control module 3316 may fetch the segment in portions by receiving a request for an initial portion of the segment from the DASH client module 3310, requesting the unicast server, via the transmission module 3306, to fetch the initial portion of the segment if the size of the segment is greater than the threshold segment size, receiving a request for a remaining portion of the segment from the DASH client module 3310, and requesting the unicast server, via the transmission module 3306, to fetch the remaining portion of the segment.

The fetch control module 3316 may obtain a provisioning control parameter, receive a service control file associated with the eMBMS service via the receiving module 3304 and the middleware management module 3314 through 3357 and 3355, and control a level of support for the unicast fetch of the segment based on the provisioning control parameter and the service control file. In an aspect, the level of support is determined based on a lesser of the provisioning control parameter and a unicast fetch parameter of the service control file. In an aspect, the controlled level of support includes a level of support that enables the unicast fetch to be active for two segment durations after the activation of a service. In an aspect, the controlled level of support includes a level of support that maintains the unicast fetch to be active.

The URL module 3318 modifies a URL for the segment in an MPD passed to the DASH client module 3310 through 3359 and 3353. In an aspect, the modified URL is capable of reverting back to the URL. The URL module 3318 may modify the URL in the MPD by adding a local host name and a port number to the URL. The URL module 3318 may modify the URL in the MPD by modifying a URL scheme.

The error repair module 3320 monitors the segment for an error, determines whether a likelihood of the segment failing based on the monitoring via the middleware management module 3314 and through 3361, and performs at least one of an early unicast fetch or segment repair based on the likelihood of the segment failing via the fetch control module 3316 and through 3363. The error repair module 3320 may perform at least one of the early unicast fetch or the segment repair by fetching additional symbols from a file repair server via the transmission module 3306. In an aspect, the error may occur when the segment has a missing portion. The error repair module 3320 may monitor the segment for an error by monitoring one or more FEC symbol identifiers received for the segment to determine a missing portion of the segment.

The bandwidth control module 3322 may consume a token from a token bucket to fetch the segment, where a number of tokens in the token bucket is increased over time and is decreased by one at 3365 each time a segment is fetched via the fetch control module 3316. The bandwidth control module 3322 may enable a unicast fetch at 3365 via the fetch control module 3316 if a byte level of a bucket is positive, where the byte level in the bucket is increased with time and is decreased by an amount of the unicast fetch. The error repair module 3320 may enable a unicast fetch if at least one FDT describing a segment that is missing or is likely to be missing is received. The bandwidth control module 3322 may place a unicast fetch on hold at 3365 via the fetch control module 3316 if a time threshold has exceeded and no segment has been received via the receiving module 3304 and the middleware management module 3314 at 3367 since a last segment was received, and resumes the unicast fetch at 3365 via the fetch control module 3316 if a segment is successfully received via the receiving module 3304.

The fetch control module 3316 determines whether a time threshold has exceeded after requesting the segment, and aborts the request if the time threshold has exceeded and the segment is not received. In an aspect, the time threshold is based on a segment duration to be received over unicast via the unicast server. In an aspect, the time threshold may be one segment duration. The fetch control module 3316 may enable a unicast fetch to request a next segment.

The apparatus may include additional modules that perform each of the steps of the algorithm in the aforementioned flow charts of FIGS. 27-32. As such, each step in the aforementioned flow charts of FIGS. 27-32 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

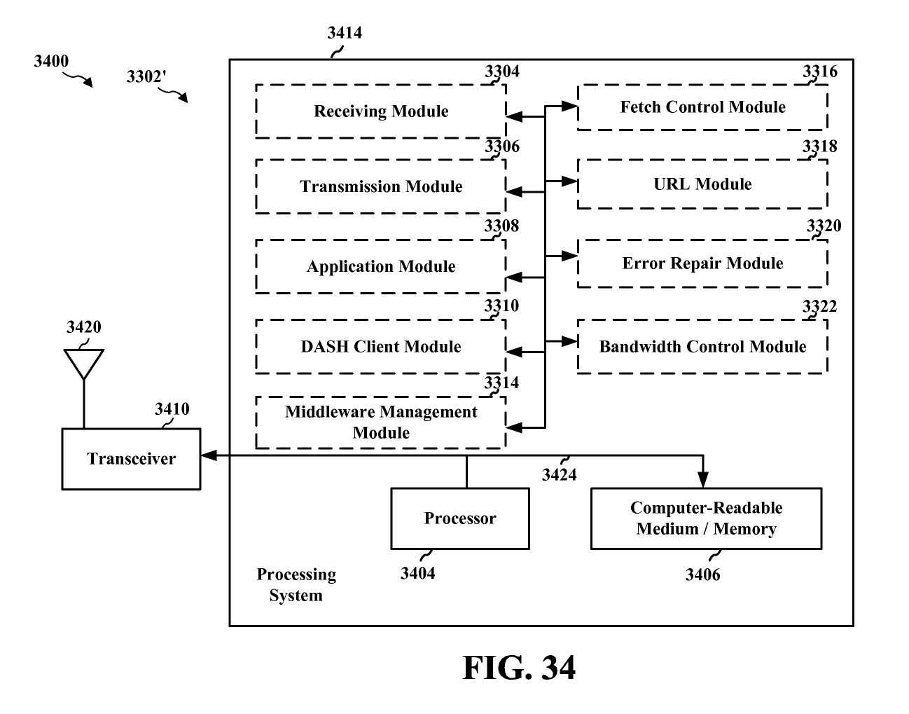

FIG. 34 is a diagram 3400 illustrating an example of a hardware implementation for an apparatus 3302′ employing a processing system 3414. The processing system 3414 may be implemented with a bus architecture, represented generally by the bus 3424. The bus 3424 may include any number of interconnecting buses and bridges depending on the specific application of the processing system 3414 and the overall design constraints. The bus 3424 links together various circuits including one or more processors and/or hardware modules, represented by the processor 3404, the modules 3304, 3306, 3308, 3310, 3314, 3316, 3318, 3320, 3322, and the computer-readable medium/memory 3406. The bus 3424 may also link various other circuits such as timing sources, peripherals, voltage regulators, and power management circuits, which are well known in the art, and therefore, will not be described any further.

The processing system 3414 may be coupled to a transceiver 3410. The transceiver 3410 is coupled to one or more antennas 3420. The transceiver 3410 provides a means for communicating with various other apparatus over a transmission medium. The transceiver 3410 receives a signal from the one or more antennas 3420, extracts information from the received signal, and provides the extracted information to the processing system 3414, specifically the receiving module 3304. In addition, the transceiver 3410 receives information from the processing system 3414, specifically the transmission module 3306, and based on the received information, generates a signal to be applied to the one or more antennas 3420. The processing system 3414 includes a processor 3404 coupled to a computer-readable medium/memory 3406. The processor 3404 is responsible for general processing, including the execution of software stored on the computer-readable medium/memory 3406. The software, when executed by the processor 3404, causes the processing system 3414 to perform the various functions described supra for any particular apparatus. The computer-readable medium/memory 3406 may also be used for storing data that is manipulated by the processor 3404 when executing software. The processing system further includes at least one of the modules 3304, 3306, 3308, 3310, 3314, 3316, 3318, 3320, 3322. The modules may be software modules running in the processor 3404, resident/stored in the computer readable medium/memory 3406, one or more hardware modules coupled to the processor 3404, or some combination thereof. The processing system 3414 may be a component of the UE 650 and may include the memory 660 and/or at least one of the TX processor 668, the RX processor 656, and the controller/processor 659.

In one configuration, the apparatus 3302/3302′ for wireless communication includes means for receiving a request to activate reception of an eMBMS service, means for receiving a request for a segment associated with the eMBMS service, means for determining whether the segment of the activated eMBMS service is available at the middleware, and means for fetching the segment from a unicast server if the segment is not available at the middleware. The apparatus 3302 may be an UE including an eMBMS middleware. The apparatus 3302 may further include means for determining a URI of the segment on the unicast server. In an aspect, the segment may be fetched from the unicast server based on the URI of the segment. The apparatus 3302 may further include means for determining whether to fetch the segment from the unicast server based on timing information in an MPD of a HTTP streaming service. The apparatus 3302 may further include means for determining whether to fetch the segment based on an FDT. In an aspect, the FDT may include information about one or more segments to be delivered over broadcast. The segment may include one or more initial segments being broadcast at or before a time of the activation of the reception of the eMBMS service.

In an aspect, the means for determining whether the segment of the activated eMBMS service is available at the middleware may be configured to determine whether the segment of the activated eMBMS service is available at the middleware before receiving the request for the segment. In an aspect, the means for determining whether the segment of the activated eMBMS service is available at the middleware may be configured to determine whether the segment of the activated eMBMS service is available at the middleware upon receiving the request for the segment. In an aspect, the segment may include a first initial segment and a second initial segment subsequent to the first initial segment, and the apparatus 3302 may further include means for fetching the first initial segment before receiving a request to fetch the first initial segment, and means for fetching the second initial segment upon receiving of a request to fetch the second initial segment.

In an aspect, the segment may include a first initial segment and a second initial segment subsequent to the first initial segment, and the apparatus 3302 may further include means for fetching the second initial segment without fetching the first initial segment if the client is activated during transmission of the second initial segment. In an aspect, the segment may include a first initial segment and a second initial segment subsequent to the first initial segment, and the apparatus 3302 may further include means for fetching the first initial segment and subsequently fetching the second initial segment if the client is activated during transmission of the second initial segment.

The apparatus 3302 may further include means for fetching the segment as a whole if a size of the segment is less than or equal to a threshold segment size, and means for fetching the segment in portions if the size of the segment is greater than the threshold segment size. In an aspect, the means for fetching the segment as a whole may be configured to receive a request for an initial portion of the segment and to request the unicast server to fetch for the segment as a whole if the size of the segment is less than or equal to the threshold segment size. In an aspect, the means for fetching the segment in portions may be configured to receive a request for an initial portion of the segment, to request the unicast server to fetch the initial portion of the segment if the size of the segment is greater than the threshold segment size, to receive a request for a remaining portion of the segment, and to request the unicast server to fetch the remaining portion of the segment.

The apparatus 3302 may further include means for obtaining a provisioning control parameter, means for receiving a service control file associated with the eMBMS service, and means for controlling a level of support for the unicast fetch of the segment based on the provisioning control parameter and the service control file. In an aspect, the level of support may be determined based on a lesser of the provisioning control parameter and a unicast fetch parameter of the service control file.

The apparatus 3302 may further include means for modifying a URL for the segment in an MPD passed to the client. In an aspect, the modified URL may be capable of reverting back to the URL. In an aspect, the modification of the URL in the MPD may include adding a local host name and a port number to the URL. In an aspect, the modification of the URL in the MPD may further includes modifying a URL scheme.

The apparatus 3302 may further include means for monitoring the segment for an error, means for determining whether a likelihood of the segment failing based on the monitoring, and means for performing at least one of an early unicast fetch or segment repair based on the likelihood of the segment failing. In an aspect, the means for performing may be configured to fetch additional symbols from a file repair server. In an aspect, the error may occur when the segment has a missing portion. In an aspect, the means for monitoring the segment for the error may be configured to monitor one or more FEC symbol identifiers received for the segment to determine a missing portion of the segment.

The apparatus 3302 may further include means for consuming a token from a token bucket to fetch the segment, where a number of tokens in the token bucket is increased over time and is decreased by one each time a segment is fetched. The apparatus 3302 may further include means for enabling a unicast fetch if a byte level of a bucket is positive, where the byte level in the bucket is increased with time and is decreased by an amount of the unicast fetch. The apparatus 3302 may further include means for enabling a unicast fetch if at least one FDT describing a segment that is missing or is likely to be missing is received. The apparatus 3302 may further include means for placing a unicast fetch on hold if a time threshold has exceeded and no segment has been received since a last segment was received, and means for resuming the unicast fetch if a segment is successfully received.

The apparatus 3302 may further include means for determining whether a time threshold has exceeded after requesting the segment, and means for aborting the request if the time threshold has exceeded and the segment is not received. In an aspect, the time threshold may be based on a segment duration to be received over unicast via the unicast server. In an aspect, the apparatus 3302 may further include means for enabling a unicast fetch to request a next segment.

The aforementioned means may be one or more of the aforementioned modules of the apparatus 3302 and/or the processing system 3414 of the apparatus 3302′ configured to perform the functions recited by the aforementioned means. As described supra, the processing system 3414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication performed by an evolved Multimedia Broadcast Multicast Service (eMBMS) middleware, comprising:
receiving a request to activate reception of an eMBMS service;
receiving a request for a segment associated with the eMBMS service;
determining whether the segment of the eMBMS service is available at the eMBMS middleware; and
transmitting a request for the segment to a unicast server upon the determination that the segment is not available at the eMBMS middleware.

2. The method of claim 1, wherein the request for the segment comprises a request for an entire segment or a request for a portion of the segment.

3. The method of claim 1, further comprising:
determining a uniform resource identifier (URI) of the segment on the unicast server,
wherein the segment is fetched from the unicast server based on the URI of the segment.

4. The method of claim 1, further comprising:
determining whether to fetch the segment from the unicast server based on timing information in a media presentation description (MPD) of a hypertext transfer protocol (HTTP) streaming service.

5. The method of claim 1, further comprising:
determining whether to fetch the segment based on a file delivery table (FDT),
wherein the FDT includes information about one or more segments to be delivered over broadcast.

6. The method of claim 1, wherein the segment belongs to one or more representations whose segments are broadcasted over eMBMS.

7. The method of claim 1, wherein the segment includes one or more initial segments being broadcast at or before a time of the activation of the reception of the eMBMS service.

8. The method of claim 1, wherein the determining whether the segment of the eMBMS service is available at the eMBMS middleware is performed before receiving the request for the segment.

9. The method of claim 1, wherein the determining whether the segment of the eMBMS service is available at the eMBMS middleware is performed upon receiving the request for the segment.

10. The method of claim 1, wherein the segment comprises a first initial segment and a second initial segment subsequent to the first initial segment, the method further comprising:
transmitting a request for the first initial segment before receiving a request to fetch the first initial segment; and
transmitting a request for the second initial segment upon receiving of a request to fetch the second initial segment.

11. The method of claim 1, wherein the segment comprises a first initial segment and a second initial segment subsequent to the first initial segment, the method further comprising:
transmitting a request for the second initial segment without transmitting a request for the first initial segment if the client is activated during transmission of the second initial segment.

12. The method of claim 1, wherein the segment comprises a first initial segment and a second initial segment subsequent to the first initial segment, the method further comprising:
transmitting a request for the first initial segment and subsequently transmitting a request for the second initial segment if the client is activated during transmission of the second initial segment.

13. The method of claim 1, further comprising:
transmitting a request for the segment as a whole if a size of the segment is less than or equal to a threshold segment size; and
transmitting a request for the segment in portions if the size of the segment is greater than the threshold segment size.

14. The method of claim 13, wherein the transmitting the request for the segment as a whole comprises:
receiving a request for an initial portion of the segment; and
transmitting a request for the unicast server to fetch for the segment as a whole if the size of the segment is less than or equal to the threshold segment size.

15. The method of claim 13, wherein the transmitting the request for the segment in portions comprises:
receiving a request for an initial portion of the segment;
transmitting a request for the unicast server to fetch the initial portion of the segment if the size of the segment is greater than the threshold segment size;
receiving a request for a remaining portion of the segment; and
transmitting a request for the unicast server to fetch the remaining portion of the segment.

16. The method of claim 1, further comprising:
obtaining a provisioning control parameter;
receiving a service control file associated with the eMBMS service; and
controlling a level of support for the unicast fetch of the segment based on the provisioning control parameter and the service control file.

17. The method of claim 16, wherein the level of support is determined based on a lesser of the provisioning control parameter and a unicast fetch parameter of the service control file.

18. The method of claim 16, wherein the controlled level of support includes a level of support that enables the unicast fetch to be active for two segment durations after the activation of a service.

19. The method of claim 16, wherein the controlled level of support includes a level of support that maintains the unicast fetch to be active.

20. The method of claim 1, further comprising:
modifying a uniform resource locator (URL) for the segment in a media presentation description (MPD) passed to the client,
wherein the modified URL is capable of reverting back to the URL.

21. The method of claim 20, wherein the modification of the URL in the MPD includes adding a local host name and a port number to the URL.

22. The method of claim 21, wherein the modification of the URL in the MPD further includes modifying a URL scheme.

23. The method of claim 1, further comprising:
monitoring the segment for an error;
determining whether a likelihood of the segment failing based on the monitoring; and
performing at least one of an early unicast fetch or segment repair based on the likelihood of the segment failing.

24. The method of claim 23, wherein the performing comprises transmitting a request for additional symbols from a file repair server.

25. The method of claim 23, wherein the error occurs when the segment has a missing portion.

26. The method of claim 23, wherein the monitoring the segment for the error comprises monitoring one or more forward error correction (FEC) symbol identifiers received for the segment to determine a missing portion of the segment.

27. The method of claim 1, further comprising:
consuming a token from a token bucket to fetch the segment, wherein a number of tokens in the token bucket is increased over time and is decreased by one each time a segment is fetched.

28. The method of claim 1, further comprising:
enabling a unicast fetch if a byte level of a bucket is positive, where the byte level in the bucket is increased with time and is decreased by an amount of the unicast fetch.

29. The method of claim 1, further comprising:
enabling a unicast fetch if at least one file delivery table (FDT) describing a segment that is missing or is likely to be missing is received.

30. The method of claim 1, further comprising:
placing a unicast fetch on hold if a time threshold has exceeded and no segment has been received since a last segment was received; and
resuming the unicast fetch if a segment is successfully received.

31. The method of claim 1, further comprising:
determining whether a time threshold has exceeded after requesting the segment; and
aborting the request if the time threshold has exceeded and the segment is not received.

32. The method of claim 31, wherein the time threshold is based on a segment duration to be received over unicast via the unicast server.

33. The method of claim 32, wherein the time threshold is one segment duration.

34. The method of claim 31, further comprising:
enabling a unicast fetch to request a next segment.

35. An apparatus for wireless communication comprising an evolved Multimedia Broadcast Multicast Service (eMBMS) middleware, the apparatus comprising, comprising:
a memory; and
at least one processor coupled to the memory and configured to:
receive a request to activate reception of an eMBMS service;
receive a request for a segment associated with the eMBMS service;
determine whether the segment of the eMBMS service is available at the eMBMS middleware; and
transmit a request for the segment from a unicast server upon the determination that the segment is not available at the eMBMS middleware.

36. The apparatus of claim 35, wherein the segment request comprises a request for an entire segment or a request for a portion of the segment.

37. The apparatus of claim 35, wherein the at least one processor is further configured to:
determine a uniform resource identifier (URI) of the segment on the unicast server,
wherein the segment is fetched from the unicast server based on the URI of the segment.

38. The apparatus of claim 35, wherein the at least one processor is further configured to:
determine whether to transmit a request for the segment from the unicast server based on timing information in a media presentation description (MPD) of a hypertext transfer protocol (HTTP) streaming service.

39. The apparatus of claim 35, wherein the at least one processor is further configured to:
determine whether to transmit a request for the segment based on a file delivery table (FDT),
wherein the FDT includes information about one or more segments to be delivered over broadcast.

40. The apparatus of claim 35, wherein the segment belongs to one or more representations whose segments are broadcasted over eMBMS.

41. The apparatus of claim 35, wherein the segment includes one or more initial segments being broadcast at or before a time of the activation of the reception of the eMBMS service.

42. The apparatus of claim 35, wherein the determining whether the segment of the eMBMS service is available at the eMBMS middleware is performed before receiving the request for the segment.

43. The apparatus of claim 35, wherein the determining whether the segment of the eMBMS service is available at the eMBMS middleware is performed upon receiving the request for the segment.

44. The apparatus of claim 35, wherein the segment comprises a first initial segment and a second initial segment subsequent to the first initial segment, and wherein the at least one processor is further configured to:
transmit a request for the first initial segment before receiving a request to transmit a request for the first initial segment; and
transmit a request for the second initial segment upon receiving of a request to transmit a request for the second initial segment.

45. The apparatus of claim 35, wherein the segment comprises a first initial segment and a second initial segment subsequent to the first initial segment, and wherein the at least one processor is further configured to:
transmit a request for the second initial segment without transmitting a request for the first initial segment if the client is activated during transmission of the second initial segment.

46. The apparatus of claim 35, wherein the segment comprises a first initial segment and a second initial segment subsequent to the first initial segment, and wherein the at least one processor is further configured to:
transmit a request for the first initial segment and subsequently transmit a request for the second initial segment if the client is activated during transmission of the second initial segment.

47. The apparatus of claim 35, wherein the at least one processor is further configured to:
transmit a request for the segment as a whole if a size of the segment is less than or equal to a threshold segment size; and
transmit a request for the segment in portions if the size of the segment is greater than the threshold segment size.

48. The apparatus of claim 47, wherein the at least one processor configured to transmit the request for the segment as a whole is further configured to:
receive a request for an initial portion of the segment; and
transmit a request for the unicast server to fetch for the segment as a whole if the size of the segment is less than or equal to the threshold segment size.

49. The apparatus of claim 47, wherein the at least one processor configured to transmit the request for the segment in portions is further configured to:
receive a request for an initial portion of the segment;
transmit a request for the unicast server to fetch the initial portion of the segment if the size of the segment is greater than the threshold segment size;
receive a request for a remaining portion of the segment; and
transmit a request for the unicast server to fetch the remaining portion of the segment.

50. The apparatus of claim 35, wherein the at least one processor is further configured to:
obtain a provisioning control parameter;
receive a service control file associated with the eMBMS service; and
control a level of support for the segment based on the provisioning control parameter and the service control file.

51. The apparatus of claim 50, wherein the level of support is determined based on a lesser of the provisioning control parameter and a unicast fetch parameter of the service control file.

52. The apparatus of claim 35, wherein the at least one processor is further configured to:
modify a uniform resource locator (URL) for the segment in a media presentation description (MPD) passed to the client,
wherein the modified URL is capable of reverting back to the URL.

53. The apparatus of claim 52, wherein the at least one processor configured to modify the URL in the MPD is further configured to add a local host name and a port number to the URL.

54. The apparatus of claim 53, wherein the at least one processor configured to modify the URL in the MPD is configured to modify a URL scheme.

55. The apparatus of claim 35, wherein the at least one processor is further configured to:
monitor the segment for an error;
determine whether a likelihood of the segment failing based on the monitoring; and
perform at least one of an early unicast fetch or segment repair based on the likelihood of the segment failing.

56. The apparatus of claim 55, wherein the at least one processor configured to perform at least one of the early unicast fetch or the segment repair is configured to fetch additional symbols from a file repair server.

57. The apparatus of claim 55, wherein the error occurs when the segment has a missing portion.

58. The apparatus of claim 55, wherein the at least one processor configured to monitor the segment for the error is further configured to monitor one or more forward error correction (FEC) symbol identifiers received for the segment to determine a missing portion of the segment.

59. The apparatus of claim 35, wherein the at least one processor is further configured to:
consume a token from a token bucket to fetch the segment, wherein a number of tokens in the token bucket is increased over time and is decreased by one each time a segment is fetched.

60. The apparatus of claim 35, wherein the at least one processor is further configured to:
enable a unicast fetch if a byte level of a bucket is positive, where the byte level in the bucket is increased with time and is decreased by an amount of the unicast fetch.

61. The apparatus of claim 35, wherein the at least one processor is further configured to:
enable a unicast fetch if at least one file delivery table (FDT) describing a segment that is missing or is likely to be missing is received.

62. The apparatus of claim 35, wherein the at least one processor is further configured to:
place a unicast fetch on hold if a time threshold has exceeded and no segment has been received since a last segment was received; and
resume the unicast fetch if a segment is successfully received.

63. The apparatus of claim 35, wherein the at least one processor is further configured to:
determine whether a time threshold has exceeded after requesting the segment; and
abort the request if the time threshold has exceeded and the segment is not received.

64. The apparatus of claim 63, wherein the time threshold is based on a segment duration to be received over unicast via the unicast server.

65. The apparatus of claim 63, wherein the at least one processor is further configured to:
enable a unicast fetch to request a next segment.

66. An apparatus for wireless communication comprising an evolved Multimedia Broadcast Multicast Service (eMBMS) middleware, the apparatus comprising:
means for receiving a request to activate reception of an eMBMS service;
means for receiving a request for a segment associated with the eMBMS service;
means for determining whether the segment of the eMBMS service is available at the eMBMS middleware;
a transceiver configured to transmit a request for the segment from a unicast server upon the determination that the segment is not available at the eMBMS middleware;
means for monitoring the segment for an error;
means for determining whether a likelihood of the segment failing based on the monitoring; and
means for performing at least one of an early unicast fetch or segment repair based on the likelihood of the segment failing.

67. A computer program product for an evolved Multimedia Broadcast Multicast Service (eMBMS) middleware, comprising:
a computer-readable medium comprising code for:
receiving a request to activate reception of an eMBMS service;
receiving a request for a segment associated with the eMBMS service;
determining whether the segment of the eMBMS service is available at the eMBMS middleware;
transmitting a request for the segment from a unicast server upon the determination that the segment is not available at the eMBMS middleware;
monitoring the segment for an error;
determining whether a likelihood of the segment failing based on the monitoring; and
performing at least one of an early unicast fetch or segment repair based on the likelihood of the segment failing.
